(19) United States
(12) Patent Application Publication
(10) Pub. No.: US 2011/0130508 A1
(43) Pub. Date: Jun. 2, 2011

(54) Topside optical adhesive for micro-optical film embedded into paper during the papermaking process

(76) Inventor: Alan David Pendley, Petaluma, CA (US)

(21) Appl. No.: 12/846,815

(22) Filed: Jul. 29, 2010

Related U.S. Application Data
(60) Provisional application No. 61/271,983, filed on Jul. 29, 2009.
(60) Provisional application No. 61/271,970, filed on Jul. 29, 2009.

(51) Int. Cl. C09J 175/04

(52) U.S. Cl. 524/507; 524/589

(57) ABSTRACT

An adhesive, micro-contact-lens system [300][400] applied to the topside of microlens arrays [10], which enables films of lens arrays to be embedded into paper during the papermaking process. The optics of the lens array is at least not degraded by the presence of the topside adhesive in areas where the microlens array is selectively exposed at the paper surface. The microlens array is intimately bonded with paper fibers in areas where the topside of the lens array is covered by paper fibers [500], thereby preventing the paper fibers from detaching, rising up or detracting from the otherwise spectacular visual effects enabled by synthetic images displayed by micro-optical films embedded into paper.

This application claims benefit of and priority to the following US provisional applications:
U.S. 61/271,983 Topside optical adhesive for micro-optical film embedded into paper during the papermaking process filed on Jul. 29, 2009 and
U.S. 61/271,970 Adhesive for polymeric security thread inserted into paper, stable against accidental laundry filed on Jul. 29, 2009.

Both of these provisional applications are incorporated by reference in their entirety.

### DESCRIPTION

1. Technical Field

This present invention generally relates to thin, optically clear, adhesive layers that can be applied to the surface of thin microlens arrays to at least maintain the optical properties of the array while bonding a portion of the embedded microlens array topside to paper fibers during the papermaking process. The present invention further relates to the application of thin adhesive layers that can be applied to embedded or windowed security threads such that they can be permanently bonded to paper during the paper making process without adding significant thickness to the caliper of the paper.

2. Background Art

### Micro-Optic Films in Banknote Paper

Micro-optical films are now being used in documents of value, such as banknotes, for counterfeit prevention. Micro-optical films can produce dynamic images that are more difficult to copy than holograms and cannot be simulated through digital copying and printing. By embedding these new security devices within the sheet of paper and allowing select portions to be exposed on the surface for viewing, potential counterfeiters would not only have to replicate the complex multi-layered micro-optical film, they would also have to make a convincing sheet of paper and display a portion of the film embedded within the paper. The task of printing the document would also present some challenges.

Steenblik et al have disclosed a very broad range of such art in [U.S. Pat. No. 7,006,294], [U.S. Pat. No. 7,333,268], and [U.S. Pat. No. 7,468,842], incorporated herein in their entirety by reference. These patents teach the creation of security elements composed of microlens arrays disposed above a micro image array with a polymeric carrier film serving as a spacer between with a thickness that approximates the focal length of the lenses. While these patents teach the use of conformal coating onto microlens arrays, it is terms of sputtered thin films and not an enabling technique for adhering these security elements into the body of banknote papers or other documents of value other than surface adhesion through conventional adhesives on the back side of the film. The present invention does not teach the creation of microlens arrays nor image arrays as described in Steenblik et al. Predating Steenblik, on Dec. 12, 1995 is the art taught by Drinkwater et al [U.S. Pat. No. 5,712,731], incorporated herein in its entirety by reference, in which microlens arrays were restricted to lenses of 50 microns or greater which in turn makes a film so thick that they cannot practically be incorporated into the body of a banknote as a windowed security thread. While the present invention could be scaled to the larger size of the Drinkwater art, the utility of a windowed security thread requiring an adhesive on top makes the topside embodiments of the present invention a poor choice for the Drinkwater art of Dec. 12, 1995.

Stephen Daniell published four patents related to optical corrections enabled by multi-layered contact lenses atop aspheric microlens arrays in [U.S. Pat. No. 6,473,238], [U.S. Pat. No. 6,490,094], [U.S. Pat. No. 6,587,276], and [U.S. Pat. No. 6,721,101], incorporated herein in their entirety by reference. These patents differ from the present invention in two key respects. First, the Daniell art trades off optical correction for optical efficiency, that is much light is discarded and compensates by backlighting the microlens array with extra light whereas the present invention makes use of reflected ambient light as the primary viewing mode. Secondly, the Daniell art requires the registration of distinct lens array layers atop one another with registration pins for alignment. The present invention is instead designed for microlenses so small that such registration as used by Daniell is not practical for a continuous ribbon. The present invention depends on self assembly of solutions coated on wet in a precise thin film and dried down to for a conformal contact lens array where coating and drying dynamics in conjunction with customized surface chemistry control the shape of each subsequent contact lens layer.

The Papermaking Process with Wet-Strength Resins

The papermaking process uses dilute solutions of cellulose fibers in water, sometimes treated with wet-strength resins. These resins provide the paper with additional strength when dry and are especially important to keep the paper from falling apart if it becomes accidentally wet.

It is very important that these wet-strength resins do not begin their chemical co-reaction until after the paper is dry, because during the dewatering and drying process the paper fibers shift and move substantially with respect to one another. In fact, there is contraction of the paper web in the cross-machine direction and elongation in the direction that the paper winds through the papermaking machine.

Gu published a US patent application [US 20080009596], incorporated herein in its entirety by reference, filed May 18, 2007 which claims a broad range of Michael Addition adducts to polyvinyl amine that aid in the use of polyvinyl amine as a dry-strength additive in papermaking. The present invention teaches one embodiment using a Michael addition reaction to effect the addition of low glass transition temperature side chains onto polyvinyl amine as one component of a multi-component, lightly cross-linked adhesive that serves the triple function of:
1. Acting as a self assembling, self registering contact lens system atop a microlens array.
2. Acting as a rewettable, wet-extensible, large contact radius adhesive to bond wet paper fibers to the lens array with a high density of contacts as the paper and embedded security thread are dried during the papermaking process
3. Acting as a reservoir for ejecting a minority of the lightly crosslinked adhesive into the nearby fiber network to react with the electrophilic wet-strength resins and to depress the glass transition temperature of the wet-strength resins in near proximity to the lens array thereby extending the reaction time of the wetstrength resin system which consequently strengthens the paper network from within.

An alternative embodiment taught by the present invention uses commercially available, water soluble, low glass transition temperature poly-primary amines to strengthen the paper network rather than modifying polyvinyl amine for that purpose.

### The Campbell Effect

A very powerful contractile force called the Campbell Effect occurs as the last condensed water is evaporated from the paper and all the fibers become set in place through hydrogen bonding. Wet-strength resins are designed to delay nearly all of their co-reaction until after the paper is dry. Papermakers know better than to fight the contractile forces of the Campbell Effect, and so do the producers of wet-strength resins. The present invention also must avoid resisting the crushing forces of the Campbell Effect.

### The Need for Topside Adhesives

Most micro-optical films embedded into paper have a dense array of closely packed microlenses. These tiny lenses are smaller than the width of a human hair and look like small hemispheres when viewed under a microscope. The lenses focus on small images on the opposite side of the transparent micro-optic film. These thin films can be slit into narrow ribbons and can be inserted into paper during the papermaking process. With a portion of the film buried within the paper and a portion selectively exposed on the surface, these ribbons are referred to as “windowed security threads.” The portion of fibers that lies over the buried part of the security thread is called “the fiber bridge.” Without some sort of bonding adhesive on the top side of the microlens array, the fiber bridge is likely to detach from the lenses internally as the paper is made and may rise up as the paper is flexed. This could potentially cause jamming in automated teller machines and other mechanical devices that process banknotes with these features.

### Bottlebrush Polymers

The prior art is rich in academic papers related to bottlebush polymers which are usually defined as main chain polymers with a dense array of short side-chains that sterically stiffen the conformation of the main chain. Matyjszewski and Pakula filed a patent on Aug. 11, 2003 [U.S. Pat. No. 7,019,082] titled, Polymers, supersoft elastomers and methods for preparing the same, incorporated herein in its entirety by reference, that teaches the use of lightly crosslinked networks of bottle brush polymers to create super-soft elastomers. These are distinguished from the present invention in that Matyjszewski and Pakula teaches that dense side-chains provide the solvent for the system which remains rubbery and super soft whereas in the presnt invention, water is the solvent and the network collapses to a hydrogen bonded, stiff, high tensile strength network when dry, not a super-soft elastomer. Moreover, the multiple purposes required of the sidechains in the present invention and the mixture of high density and low density attachment points on the linear polymers used in the present invention make for a very different, non-idealized definition of bottlebrush polymer network used in the present invention when compared with the academic literature on the subject and Matyjszewski and Pakula.

### Why Conventional Adhesives Do Not Work

Microlens arrays are inherently micro-rough. The sheet of paper fibers is randomly tangled and is also micro-rough. The traditional method for bonding two micro-rough surfaces is to apply enough adhesive to fill the micro-roughness of both surfaces and use pressure as the adhesive is activated, cured and set. A typical adhesive bond between two micro-rough surfaces will use between 15 and 50 microns of adhesive or more. However, the traditional approach does not work in this case for four reasons:
1. An adhesive coating as thick as the traditional method would fill the spaces between the lenses and destroy the focusing power of the lens array.
2. Commercially available or published adhesives do not conform well to the surface of microlenses, a characteristic which harms the optical properties of the microlens array.
3. Commercially available or published adhesives that are coated on very thinly to approximate a conformal coating do not provide adhesion.
4. Using less than 2 microns of adhesive material to laminate a micro-rough film to a mat of wet paper fibers as they are compressed, suctioned, and dried is unprecedented.

Stated another way, adhesive systems that are commercially available or previously published, when applied to the top side of microlens-based security threads, either destroy the optical effects of the microlenses by being too thickly applied, have a mismatched refractive index or, when applied thinly enough to preserve the optics of the microlens array, provide inadequate adhesion.

A new adhesive paradigm is needed to solve this problem and new materials need to be developed.

### SUMMARY OF THE INVENTION

### Overview

Chemically similar materials bond easily to each other, and chemically different materials tend to bond poorly, unless they react with each other. The adhesive of the present invention creates a chemical transition between two unlike materials so that they bond well together. When the chemistry of the lenses is very different from the chemistry of the fibers, this transition is more easily done in at least two adhesive layers. Each adhesive layer is designed to react with or adhere to its intended surface and to react with another adhesive layer. Layer 1 [300] holds onto the base lens [10][11] and never detaches. It also must spontaneously conform closely with the shape of the lens as the solution dries. Layer 2 [400] must also conform closely to the shape of the lens and readily wet and react with layer 1 so that the two layers never separate. The second layer is designed to form a contact lens over the original lens working with the optics of the layer 1 adhesive. Layer 2, after being coated on and dried is rewetted as the security thread is introduced into the paper. Layer 2 must also attach with all wet fibers which contact it and maintain an adhesive fibril connection between layer 1 and each contacted fiber. In the areas where the security thread is exposed in the window, the recently re-swollen adhesive must dry back into a good shape for optical purposes.

### Primary Design Requirements

This coated-on contact lens system serves two purposes:
1. The main purpose of the coating in the windowed area is to show off the optical effects of the microlens array.
2. In the area where the microlens array is buried beneath the fiber bridge, the purpose of the second layer coating is to act as an adhesive by attaching with wet paper fibers and never letting go, in a way that does not resist the crushing forces of the Campbell Effect.

For optical purposes, layer 2 must have a high refractive index in order to refract light over a short distance. When layer 1 is very thin, on the order of 25 nm, its refractive index is not influential. When layer 1 is thicker, its refractive index should both be close to that of the base lens and layer 2 or it should be lower, depending on the intent of the optical design.

Matched refractive indices between the primary lens and added on conformal contact lenses preserve the optics and slightly improve the contrast by reducing the non-function area between the lenses. The lenses are effectively fattened up. A lower refractive index for layer 1 causes light to be reflected at high angles near the line-of-sight center of the lens around the periphery of the lens and acts like a stop aperture array. This in turn improves the depth of field at the expense of some image brightness. The Nov. 1, 2004 issue of Applied Optics explains a similar system called “Integral imaging with improved depth of field by use of amplitude-modulated microlens arrays” by Manuel Martinez-Corral, Bahram Javidi, Raul Martinez-Cuenca, and Genaro Saavedra, incorporated herein in its entirety by reference. The difference between the present inventin, which in some embodiments uses a lower refractive index in the first conformal contact lens than that of the second conformal contact lens and the Applied Optics article is that they described a system of opaque masks fixed on the center optical axis to block differing fraction of the center of each lens. Additionally, the rejection of light from the center of each lens and from the periphery enabled by the embodiment of the present invention with a low refractive index first coating is angle-independent. That is, over a wide range of tilting and viewing angles, the improvement in the depth of field while maintaining special resolution still holds. The security features to which the present invention is surface coated before insertion into paper are often designed to be viewed at differing angles by tilting. When the underlying optical design depends on tilting the security feature, the embodiment of using a lower refractive index for the first coating is important.

However, the price of improving the depth of field and thereby gaining greater angle independence for viewing the feature is brightness. The loss of brightness cause by throwing away unwanted photons that lower the depth of field can be paid for in at least two ways:
1. The back side diffuse reflective layer can be optimized to return the maximum amount of light possible using a highly efficient diffuse reflective layer, including but not limited to the removal of small holes that enable the viewing of the feature in transmission by holding the banknote up to the light.
2. The second coating can be formulated to be effectively a sponge-like structure that dries down to a nano-rough conformal contact lens coating that provides anti-reflection characteristics. In volume 14 of Nanotechnology, 2003, pp. 946-954, I. D. Nikolov, K. Kurihara, and K. Goto published an article titled, Nanofocusing probe optimized with anti-reflection coatings for a high-density optical memory, incorporated herein in its entirety by reference. In this article the authors show how important it is for microlens arrays to use antireflection coating to obtain maximum optical efficiency, which they achieved using vapor coating techniques of different inorganic oxides of varying refractive index upon a gallium phosphide microlens. The present invention uses balanced water based polymer chemistry to achieve a similar effect in one, two, or three coatings on a microlens array film that also functions as an adhesive between the lenses and paper fibers. In the Journal of Non-Crystalline Solids, volume 287, 2001, pp. 130-134, Cortazar et. al, published an article titled Hydrophilic sponges based on poly(hydroxyethyl acrylate) incorporated herein in its entirety by reference. Like the present invention in some embodiments that are designed for anti-reflection coatings, these structures dry down to form microscopic pores that create a gradient index of refraction between air and the substrate that they coat. The present invention, by contrast, uses, in some embodiments, a formulation with a higher refractive index that matches that of the underlying microlens in the fully condensed form with the porous structure creating the anti-reflection coating. These sponge-like embodiments are also particularly effective at ejecting small amounts of uncrosslinked materials into the fiber network which react with the wet-strength resins and build the contact radius of fiber-to-fiber bonds as well as depress the glass transition temperature of the wet-strength resin system, when glass trasition temperature depressing species are included in the formulation, thereby driving the reaction forward and preventing near proximate fibers from easily detaching under the stress of papermaking or daily circulation.

Because the lenses are so close together, the coating thickness on the lenses cannot be much more than 1.3 microns thick in total at the top and sides, and not much thicker than 3.6 microns in the triangular area between the lenses. These are the limitation for a dry coating on 20 micron lenses in a hexagonal-close pack array with about two microns between the lenses. Different lens sizes and lens spacing would require a somewhat different coating thickness for the topside adhesive. One intention of the present invention is to provide a set of chemical components that can be brought together in different proportions to adjust for design changes in the size, shape, surface chemistry and spacing of micro-optical elements.

For adhesive purposes, layer 2 must swell on contact with water and become pliant and extensible. Layer 2 must also become very adhesive with the wet paper fibers, while never letting go of the base lens through its contact with layer 1. Therefore, it is necessary to include in the formulation of layer 1, chemistries that can be made very adhesive with the base lens and will react with layer 2 and bond strongly upon drying.

### Conformal Coating of Lens Array

To maintain the optical power of the lenses, the coated on adhesive must act like a contact lens. Given the small size and dense packing of the lenses, it is not practical to register a pre-molded layer on top of the primary lenses as is taught in the prior art. It is an intention of the present invention to act as a self-assembled, conformal coating that dries down to a registered array of contact lenses, in one or more layers. When a contact lens is placed upon a primary lens, one may either seek to maintain the optical properties of the primary lens or improve upon them. Both are possible with the present invention. This application is focused on maintaining the optical properties of the primary lens while co-pending and subsequent applications will address optical improvements made possible by the present invention. It is another object of the present invention to be able to add one or more refractive contact lens layers onto microlenses in general, with and without self assembled diffractive texturing.

Chemicals that highly wet the primary lens material will tend to fill the valleys between the lenses as the solution dries down. Chemical which are highly phobic to the material that the lenses are made from will tend to form beads or globules on top of the lens array as the solution dries. Only chemicals that are intermediate between the two tend to be conformal. By devising strategies for sensitive tuning of the lens conforming aspects of the present invention, both refractive index and coated-on contact lens shape can be controlled. If this were the only requirement, the task would be one of surface chemical balancing. The present invention must achieve a self-registering conformal contact lens array which is also optimized for correct refractive index and has a high tensile strength re-wettable adhesive for bonding with fibers in the paper making process. For reasons of cost, it is desirable to achieve these two separate purposes in the minimum number of coatings without sacrificing optics or adhesion.

### Adhesion to Wet Fibers

The prior art is rich in literature having to do with resins that adhere well with wet paper fibers, but banknote papers are not simply cellulose fibers; they are beaten or “well developed” cellulose fibers coated in wet-strength resins. The formulation of layer 2 must have chemical groups that stick strongly to wet paper fibers coated in wet-strength resins. All cellulose-based paper systems rely heavily on hydrogen bonding between fibers and banknote papers that use wet strength resins are no exception. Layer 2 must be rich in short range bonding chemical groups, including hydrogen bonding groups.

A second class of short range bonding groups useful for the layer 2 adhesive is Vander Waals bonders. Small hydrocarbon clusters form good short range bonds whether wet or dry. While the water based nature of the papermaking process does not allow a high density of these hydrophobes, a small number are very helpful for adhesion to wet fibers.

A large number of carboxylates, primary amines and sulfonates assist in the adhesion of Layer 2 to wet paper fibers coated with wet strength resins. The two major classes of wet strength resins, PAE (polyamide epichlorohydrin) and PAAE (polyamidoamine epichlorohydrin), react covalently at elevated temperatures with carboxylates and react at room temperature with primary amines and sulfonates. Carboxylates are electro-statically attracted to wet strength resins. Primary amines and carboxylic acids are attracted to each other electro-statically. Carboxylates and primary amines serve the triple function of being good wet adhesion promoters, good dry adhesion promoters through covalent bonding, and assisting in the capacity to re-swell rapidly when wet.

Ethoxylated chains bound to the layer 2 adhesive also assist in wet adhesion to the paper fibers and serve other purposes described below.

### High Refractive Index

Many adhesive polymers that are commercially available have refactive indices in the range of 1.44-1.49. By contrast, micro-optical elements such as prism couplers, micro-lenses, and diffraction elements are made from organic materials with a refractive index in the range of 1.51-1.55. The chemistry of the present invention must be capable of matching the refractive index of the underlying material while meeting all of the other requirements. Commercially available polymers with such a high refractive index do not have all of the other material and process characteristics required.

Both polyvinyl alcohol and polyacrylic acid can be purchased in the desired refractive index range with water solubility and good adhesion to wet fibers. However, to achieve all of the desired characteristics, chemical modifications or custom blending are useful.

### Optical Clarity

The present invention must be optically clear from color and haze in a thin film. Color and haze in a thick film are not relevant. To avoid haze, the present invention uses polymers that are closely matched in refractive index or are miscible. Generally, it is best to begin formulation for the present invention with transparent, water soluble, high tensile strength, high refractive index, high-to-moderate molecular weight polymers which may or may not be modified chemically.

Window glass, when viewed through the pane is transparent. Viewed on edge it appears green because of iron impurities that give a green hue in a very thick layer. Similarly, the present invention can tolerate chemistries with a significant amount of color in a thick layer, but with little color contribution in a dried down layer less than 2 microns. Given the thin dimensions of the present adhesive contact lens invention, there is little opportunity to intentionally add color to the images produced. Therefore, it is best to use formulations that do not contribute significant color, but chemicals that have other beneficial attributes can be used if they are not fully clear of color in the visible spectrum.

### Wet Extensile Formulation

The present invention is constrained by optics to less than 2 microns of coating thickness (and about 1 micron on the lenses) which must bond to a very rough and dynamically shifting mat of initially wet paper fibers. Geometrically, the only way to use such a thin coating to bond strongly with paper fibers is to redistribute the thin coating into pads of adhesive that partially envelope the contacting fibers and extended adhesive fibrils that bridge between the base lens and nearby fibers. The insertion of the microlens film into the paper making process wets the surface of the lenses with water. Moisture is the trigger for redistributing the thin adhesive coating. The coated-on formulation, while never letting go of the base lens must swell with water to enlarge and soften the adhesive layer. As the mat of fibers is pressed into the swollen adhesive layer, the adhesive partially envelops and adheres to the contacting fibers. The swelling and rewetting is also the trigger to allow the material to redistribute into a wet, extended fibril after contact with a wet paper fiber. In the wet state, the fibril most preferably will be very extensible without significantly resisting the movement of the fibers, but in the dry state it must have a very high tensile strength.

### Adhesion to Shifting Fibers

There are at least three circumstances in which the layer 2 adhesive makes contact with a wet fiber that will move from its original place.

1. When fibers are pressed into the swollen adhesive layer 2 as the paper sheet is formed, the fibers are almost half embedded into the adhesive and some of those fibers may move with respect to one another. As the fiber moves away from its original attachment point in the adhesive, if the adhesive chemistry is strongly adhesive to both lens and fiber and is very pliant when wet, it forms an extended adhesive fibril that joins the adhesive-coated microlens to the fiber. Fibrils with a large radius of attachment to both the lens and the fiber tend to distribute stresses well and will not fail as long as the tensile strength of the adhesive is high and there are many such fibrils.

2. Another case of fibril formation happens when the fibers nearby the swollen adhesive come into momentary contact as the paper is compressed through nip rolls, which are commonly used in the papermaking process. As the pressure is released, the fiber may spring back away from the adhesive-coated lens array and create a small adhesive fibril between the base lens and the sprung-back fiber. As long as this fibril can tolerate additional shifting of the fibers as the whole system dries, it will contribute to the overall adhesive strength between the lenses and the fiber bridge.

3. In the drying section of the papermaking machine, as the last drops of water evaporate, the entire sheet contracts with tremendous force known as the Campbell Effect. The layer 2 adhesive is designed to not resist this powerful force. Layer 2 is designed to tolerate the Campbell Effect by extending fibrils as the paper is moving. The contractile force of the Campbell Effect is tolerated because of the many attachment points between the lenses and paper fibers and their continued ability to shift and extend as the paper is being dried. Most preferably, the adhesive layer 2 dries just after the rest of the paper sheet. As the adhesive layer 2 dries, the many hydrogen bonding sites are set and co-reactive covalent bonders are permanently linked as they co-react. Upon drying, the pliant layer 2 adhesive becomes a high refractive index, high tensile strength, relatively stiff (but not brittle) connecting member between the base lens (through its connection to layer 1) and any paper fibers that come into contact and help form extended ahesive fibrils. Preferably, the layer 2 adhesive is designed to dry after the rest of the paper sheets so it remains somewhat pliant for the final Campbell Effect. Adhesive formulations that have functional groups that are more difficult to dehydrate, provided they contribute in other ways, can achieve this goal. Primary amines, carboxylates and sometimes ethoxylate chains can provide this characteristic when they are surface-positioned on a molecule of significant size.

### Large Contact Radius Adhesive Fibrils

As mentioned above, formulations that provide a large radius of contact for extended adhesive-fibrils distribute stresses evenly across the fibril. The contact radius is not half the diameter of the fibril; it is the radius of curvature as the material is viewed in profile or section view. Small contact radii cause applied stresses in a fiber network to concentrate at the small radius leading to low force failures at the small radii. Obtaining a large radius adhesive fibril in the dry state—both at the contact with layer 1 and the contact with the fiber—starts with the rheology, extensibility and interconnectedness of the rewetted adhesive. First and foremost, the layer 2 adhesive must not release from layer 1 even in the wetted state. That means a high density of covalent bonds is required between layer 2 and layer 1. Also required is a releasing of the hydrogen bonds that bind layer 2 together. In the rewetted state, most of the hydrogen bonds are free to slide past one another, a key aspect of redistributing a thin film of adhesive. Layer 2 also requires, low force extensibility in the wet state, balanced with enough internal crosslinking that the fibrils do not sever as the paper fibers shift. Additionally, a lightly crosslinked network within the layer 2 adhesive contributes to a large radius fibril. Using molecules that have inherent extensibility allows for a slightly higher crosslinked network in layer 2, which in turn increases the radius of the fibril. Taken too far, crosslink density in the layer 2 adhesive prevents fibril extension. The radius at the lens base may increase but the radius of contact at the fiber decreases when the layer 2 crosslinking is too high.

### High Density of Fibril Contacts

An array of 20 micron diameter lenses with a 2 micron gap between them has 9543 lens tops or sides per square millimeter, into which a fiber is either embedded or connected with a large radius fibril. The triangular area between the lenses provides a reservoir for a thicker amount of layer 2 adhesive. This area becomes either embedded with paper fibers or is the attachment site for extended adhesive fibrils, after momentary fiber contact or shifting fiber to fiber position. Counting each lens once (a conservative estimate) and each triangular “meadow” between the lenses once, each square millimeter of microlens array has the potential for about 19000 adhesive pads or microfibrils connecting the lens array film to the fiber network of the paper above on the top side. The roughness and porosity of the fiber network, even though it forms a negative molded shape of the lens array during the paper making process, may result in fewer connections per square millimeter. Nevertheless, if these bonds of are high tensile strength and well shaped, and their attachment interfaces have good integrity, the cumulative effect of so many connections over a small area is formidable. Additional difficulty comes in making the connections survive the dynamic shifting and contracting nature of the fiber network during papermaking.

### High Force Failure Mode

Formulating the present invention to result in a high force failure mode is important to maximize the longevity of the bond between the lens array and the fiber network. This is most important during the papermaking process and subsequent printing processes. It is also important during normal circulation of documents of value such as banknotes. Fortunately, normal document circulation does not put significant stress on a well bonded fiber bridge that is connected with the lens array.

If the number of bonded contact points between the micolens array and the paper fiber network is defined as N and the quality and strength of the average bond is defined as Q then the total force required to break the layers apart is proportional to N×Q. There is some product of N and Q that is stronger than the force binding the lenses to the carrier film. Longevity of the adhesive bond between the lens array and the fiber network is aided by maximizing N and Q initially, so that their product is significantly higher than the force bonding the lenses to the carrier. Wear and time related degradation of the fiber network and the adhesive bonds connecting the lenses to the fiber network will decrease both N and Q over time. By maximizing both at the outset, the degraded values of N and Q will still be sufficient to keep the materials together as the product ages with use and time.

### High Tensile Strength Adhesive

As long as the tensile strength of the dried layer 2 adhesive is stronger than the fiber-to-fiber bond within the paper network, and stronger than the adhesive bond between the lenses and the carrier film, the lenses will always remain bonded to the paper. (This assumes that the bond strength between adhesive and fiber and adhesive and lens are also higher than the bond strength between the lenses and the carrier film) Hydrogen bonding and crosslinking add to a high tensile strength provided the molecular weight distribution of the adhesive is missing short chain polymers.

Overly crosslinked adhesives become brittle which can harm ultimate tensile strength. Brittle adhesives also fail at the fiber attachment point or the lens attachment point. The present invention requires high tensile strength adhesives that are not brittle.

The present invention has many simultaneous constraints that must be met. Some formulations may excel in all areas but fall somewhat short in terms of tensile strength. For those formulations it may be necessary and useful to add a small fraction of nano-scale fibers to boost the tensile strength without scattering light.

### Low Viscosity Requirement

The present invention needs to conform to the microlens array as the adhesive solutions are coated on and dried. One way to keep the viscosity of the solutions low enough for the solids to have high mobility as they dry into a conformal coating is to make them dilute. However, it is costly to coat and dry very many layers. As was described above, high tensile strength comes with high molecular weight which in turn causes viscosity to build when the solutions are concentrated. To maintain high tensile strength and keep the viscosity initially low as the solutions are applied, one approach is to blend together different co-reacting polymers in solution just before coating them onto the lenses. A combination of steric hindrance in the design of the coreacting molecules and dilution of the co-reactors in one or more polymers that do not crosslink with the co-reactant is one way to slow the rate of crosslinking. If the non-crosslinking polymers have other beneficial attributes like, moderately high molecular weight, covalent reactivity with layer 1 and with the fibers, high refractive index, rewettable and swellable in water but is bound to the co-reactors only through short range forces, then initial viscosity can be low while many other design requirements are met. In this way, the solids content of the layer 2 adhesive can be kept high while the initial viscosity is low, without sacrificing the other requirements. It is the steric hindrance of the co-reactants and dilution into polymers that do not co-react that allows the multi-part adhesives to be mixed in-line, coated, and dried in as few as one or two coated-on layers.

### Local Strengthening of Nearby Fiber Bonds

Within the tangled mat of paper fibers, most fibers are deeply entangled in the sheet and some are partially exposed at the surface. A small minority of fibers lies in a serpentine path on the surface and has little entanglement within the paper sheet. These are the fibers which are most easily released from the sheet under conditions of forced de-lamination. Because of these easily released, weakly-bonded fibers, a preferred embodiment of the present invention seeks to increase the fiber-to-fiber bond strength in the near vicinity of the layer 2 adhesive. It does so by letting a minority of the layer 2 adhesive penetrate a few fiber layers into the sheet and increase fiber-to-fiber bonding strength.

During compression of the paper sheet through nip rolls and other compressive steps in the papermaking process, the reswollen adhesive is squeezed like a wet sponge and some dissolved solids will be ejected into the surrounding fiber network. The local fiber network can be strengthened when the ejected material either adds to the existing wet-strength resin layer or increases the strength of the existing wet-strength resin system by catalyzing or extending the reaction of those resins. Ejected materials that strengthen the fiber-to-fiber bond of the nearby paper network by addition only are called Fiber Bond Adducts. Ejected materials that strengthen the fiber-to-fiber bond of the nearby paper network by catalysis or by depressing the glass transition temperature are called Wet Strength Synergists. A combination of the two classes of fiber-bond strengthening materials is possible in a single molecule and is the preferred embodiment. By designing Wet Strength Synergist and Fiber Bond Adduct characteristics into adhesive layer 2 molecules, such molecules that remain in layer 2 contribute to the bond between lens and fiber, and such molecules that are ejected during paper compression become available to strengthen the fiber-to-fiber bonds of the nearby paper network.

### Non-Tacky Dry Surface

Topside adhesive formulations of the present invention must be non-tacky when dry in the windowed areas exposed to the public. A high concentration of hydrogen bonding surface groups and some crosslinking helps create a dry, non-tacky surface. Additionally, a thin layer of paper size coats the entire sheet of paper after the microlens thread is inserted into the paper web. The final layer of paper size helps to further crosslink and hydrogen bond the exposed lens surfaces and is a contributor to a non-tacky surface.

### Non-Toxicity

Because the topside adhesive is in contact with the public in the windowed area, it must be nontoxic. Chemistries that are water-soluble are more easily excreted from the human body, so all molecules used in the topside adhesive are water soluble, at least in warm water. Very large molecules do not transport through skin. All molecules used in the topside adhesive are either very large or small non-toxic molecules like sodium chloride. The volume of material in the topside adhesive is microscopic and is well fixed to the underlying lens through covalent crosslinking and hydrogen bonding. Moreover, the entire surface of the paper and windowed thread area is coated-over and encapsulated by a thin, transparent, crosslinking paper size layer. The present invention is therefore non-toxic in the final form presented to the public.

### BRIEF DESCRIPTION OF THE DRAWINGS

FIG. 1 Microlens array, in section view (FIG. 1A) and plan view (FIG. 1B) showing “short valley” transect without adhesive coating.

FIG. 2 Microlens array, in section view showing “short valley” transect [100] coated with conformal adhesive contact lens layer when wet (FIG. 2A), when dry (FIG. 2B), and in plan view when coated with dry adhesive (FIG. 2C). The adhesive in the triangular areas between lenses [50] is not shown in FIG. 2C.

FIG. 3 Microlens array, in section view (FIG. 3A) and plan view (FIG. 3B) showing “long valley” transect [200] without adhesive coating.

FIG. 4 Microlens array, in section view showing “long valley” transect [200] with adhesive coating when wet (FIG. 4A) and when dry (FIG. 4B), and in plan view when coated with adhesive. FIG. 4C is a rotation of FIG. 2C.

FIG. 5 Enlargement of microlens film in section view

FIG. 6 Enlargement of microlens film in section view with conceptual depiction of layer 1 molecules in conformal coating on lens array surface

FIG. 7 Extreme enlargement of microlens surface in section view with conceptual depiction of one embodiment of layer 1 that uses side chain modification of high molecular weight linear polymers to promote lens side adhesion while leaving a high density of covalently reacting, yet un-reacted side chains for subsequent attachment to layer 2.

FIG. 8A Plan view of the boundary between the lens-exposed region and the region covered by fibers thus forming the fiber bridge.

FIG. 8B Plan view of the boundary between the lens-exposed region and the region covered by fibers thus forming the fiber bridge showing attachment of paper “fines” to the lens surface caused by formulating a high density of highly kinetic side-chains onto one or more of the blended polymers of the top-side adhesive formulation. FIG. 8A depicts a kinetically slower formulation.

FIG. 8C Conceptual section view of the fiber bridge indicating fibers that lie across multiple lens tops together with co-entangled fibers—not to scale.

FIG. 8D Plan view of crossing fibers that lie across the tops of several lens-tops, indicating the large radius adhesive-to-fiber contact zone, [420], and the enhanced fiber-to-fiber contact zone, [510e].

FIG. 8E Enlarged section view of fiber lying across the top of a microlens indicating the ring of large radius, redistributed adhesive [420] and specifically that radius [410].

FIG. 8F Conceptual section view of boundary between entangled fibers and the lens array specifically in regions where the fibers are more tangled and are not predominantly lying atop the lenses.

FIG. 9 Stack of Interfaces—adhesion and cohesion zones between interior of carrier film and the interior of the paper fibers.

FIG. 10 Process flow for inline application of topside adhesive system as the microlenses are being made. Pumping and mixing of one part, two parts (or optionally three part) adhesive primer and rewettable topside adhesive, coated and dried sequentially, (FIG. 10A) or coated and dried concurrently with a two station slot die coater [954] [956] and a single drying section [974], (FIG. 10B). FIG. 10 depicts coating steps without respect to the precise coating technique such as meyer rod coating, slot-die coating, reverse roll coating or many other techniques known to one skilled in the art.

### BEST MODE FOR CARRYING OUT THE INVENTION

Assumption #1: Because we cannot test the durability of the topside adhesive in circulation before the adhesive is introduced, we assume that the attachment method that leads to the strongest destructive delamination force will have the longest adhesive life in circulation, provided the adhesive itself does not degrade significantly over time. Paper does degrade slowly with circulation.

Assumption #2: It is more practical to design a topside adhesive that has the dual function of an adhesive contact lens and a rewettable fiber adhesive that does not require registration with the windowing process than it is to design a film that is intermittently coated with adhesive across the web so that the registered windowed areas are absent adhesive as the film windowing and selectively applied adhesive are co-registered.

The optical benefits of the present invention will further validate assumption #2.

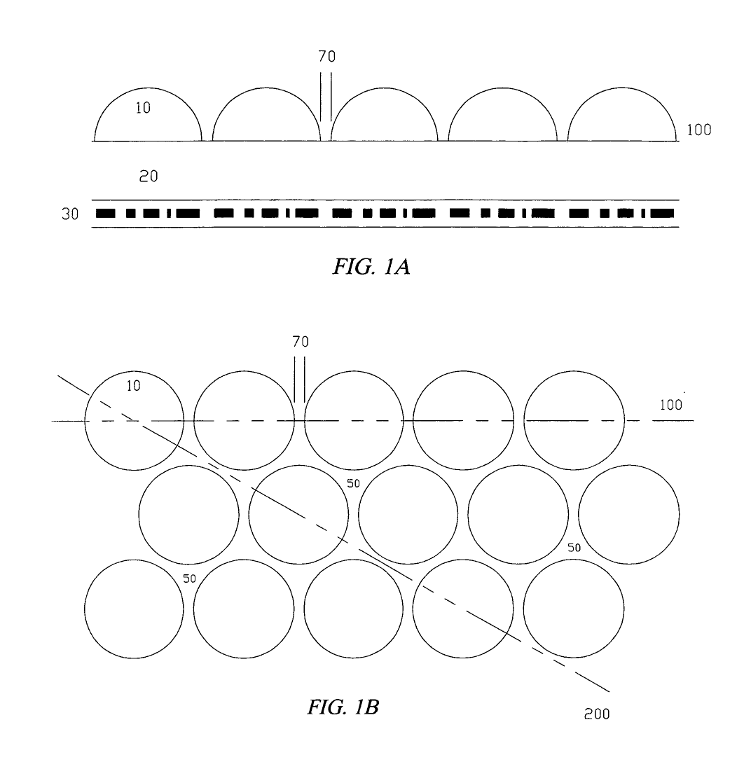

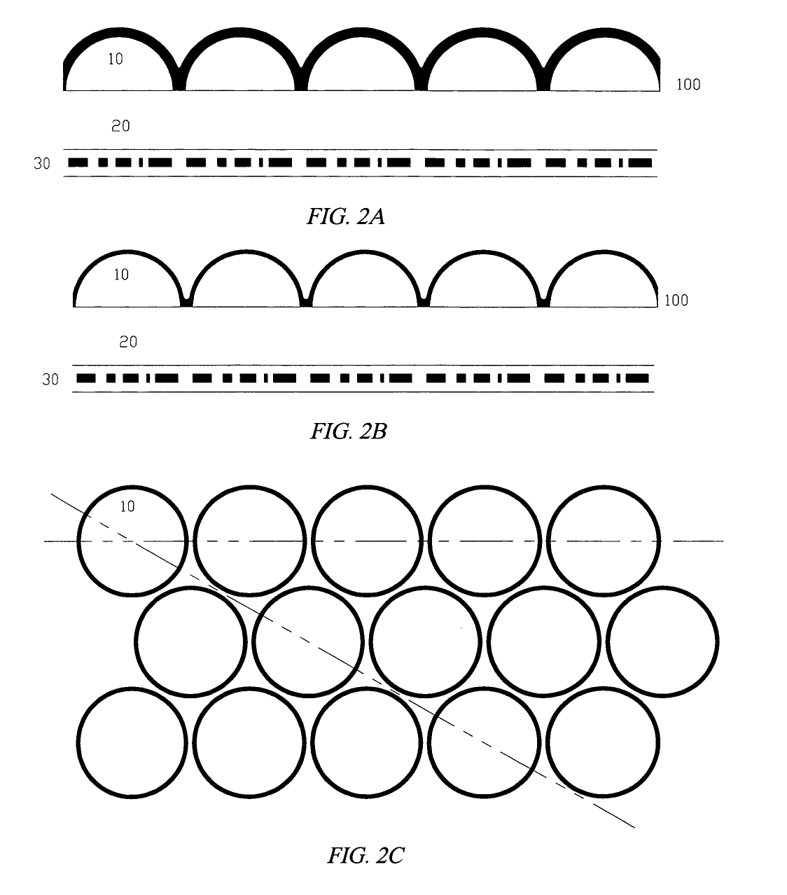

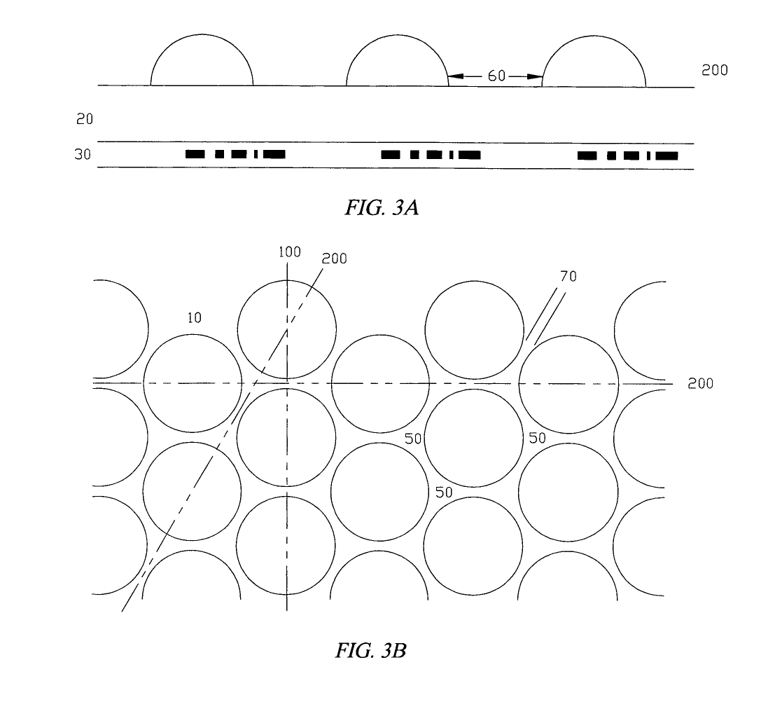

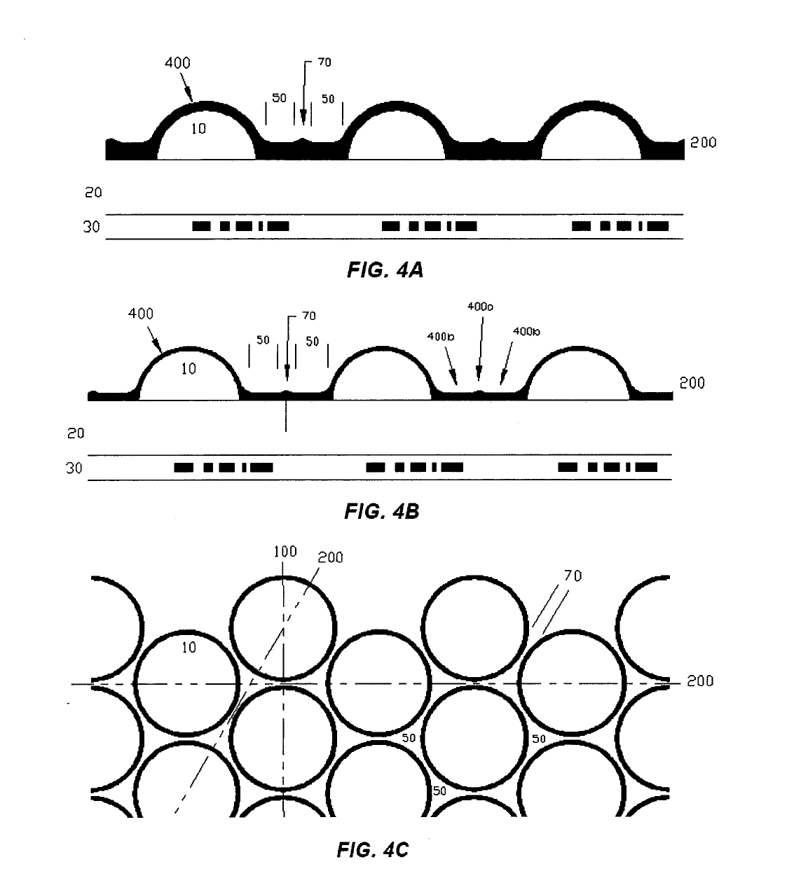

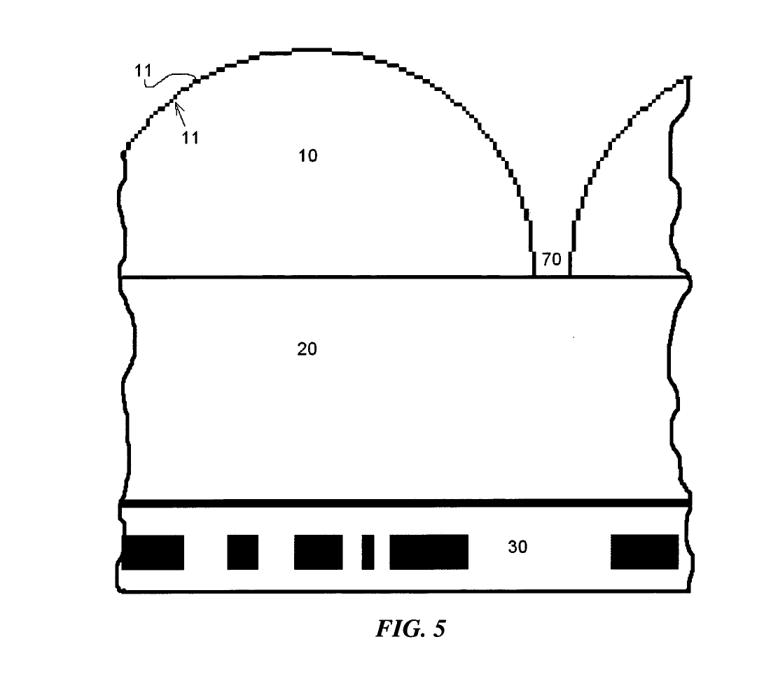

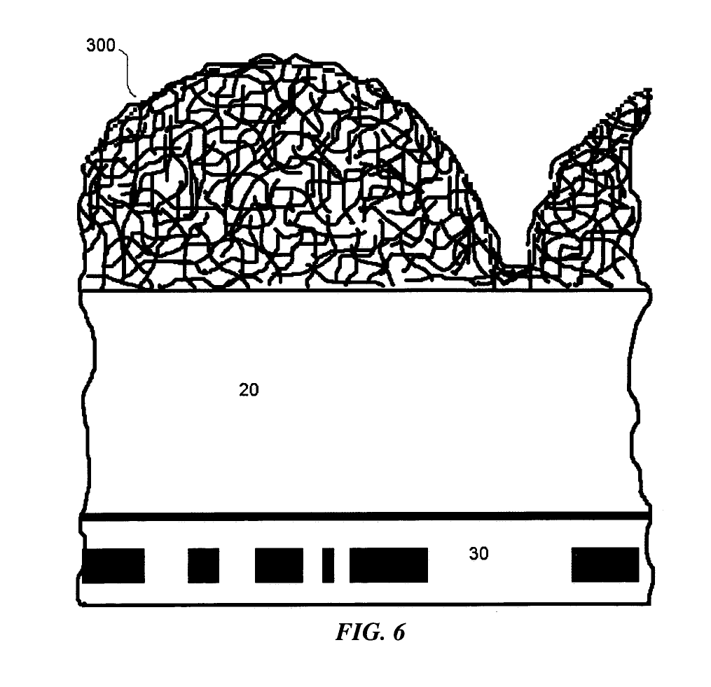

FIGS. 1 and 3 show different transects through a hexagonal close-packed microlens array with high numerical aperture. The lenses are spaced apart and the present invention “fattens them up” with an optically compatible adhesive contact lens system that is formulated to be coated and dried on so that it spontaneously self assembles into a conformal coating. FIGS. 2b and 4b show the dried-on conformal lens coating in the short valley and long valley transects. The term, “short valley” in this application, refers to the nearest approach between two spaced apart lenses in a lens array and the short valley transect [100] is the line that passes through the center of the microlenses along their closest approach. The term “long valley transect” is the line that passes through the center of microlenses in their farthest line of sight approach to each other [200]. In a hexagonal close packed array, the short valley transect and long valley transect are perpendicular to each other. The drawings of this application use a hexagonal close-packed array but other packing arrangements are possible including those that use elliptical lenses.

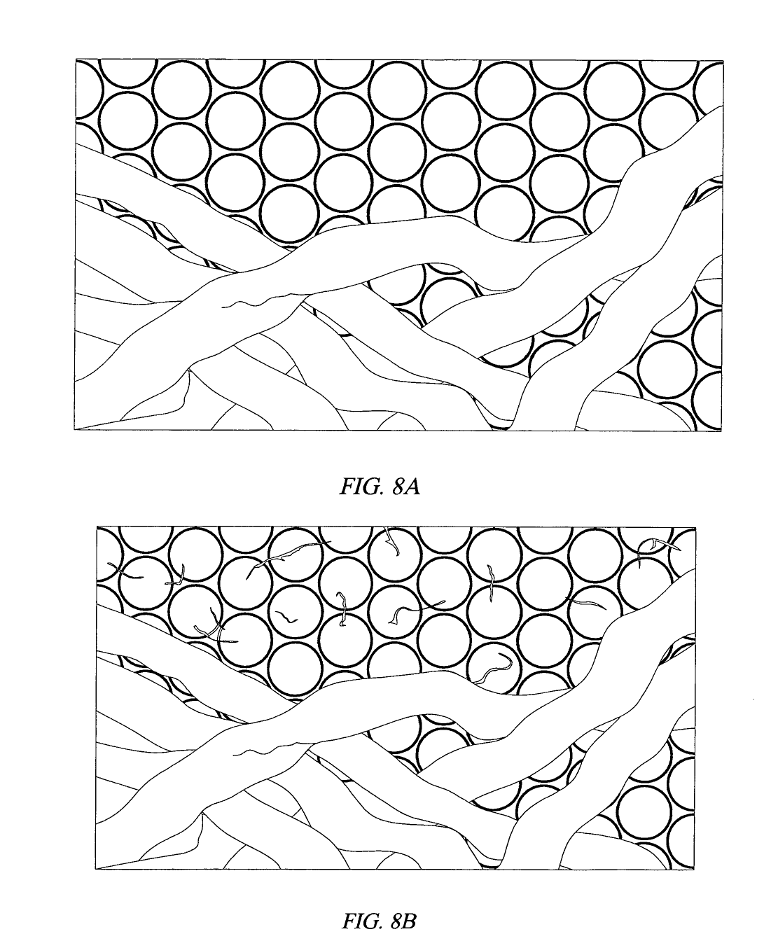

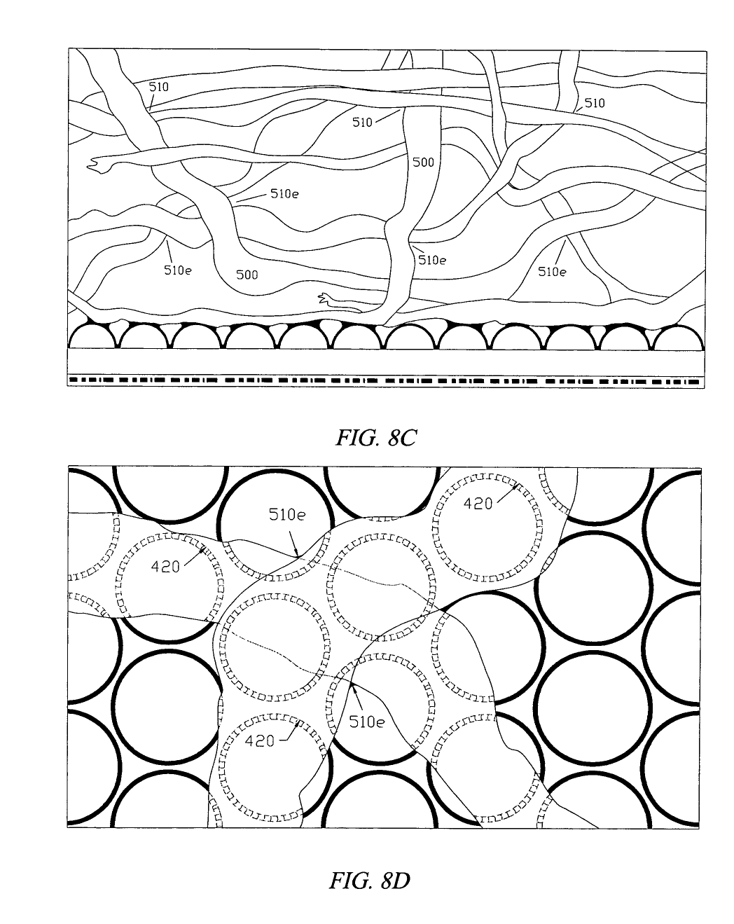

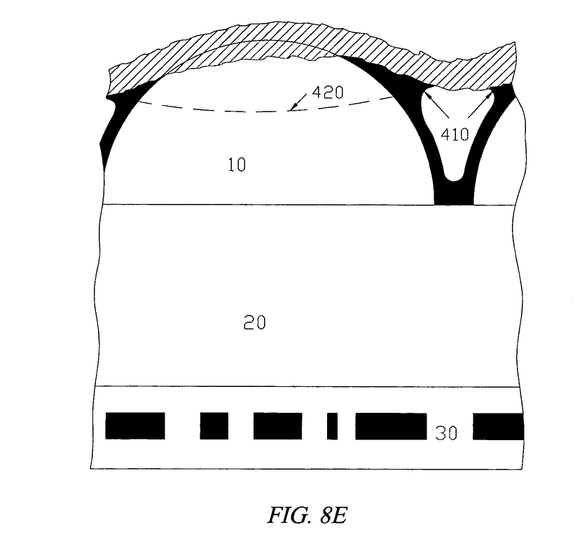

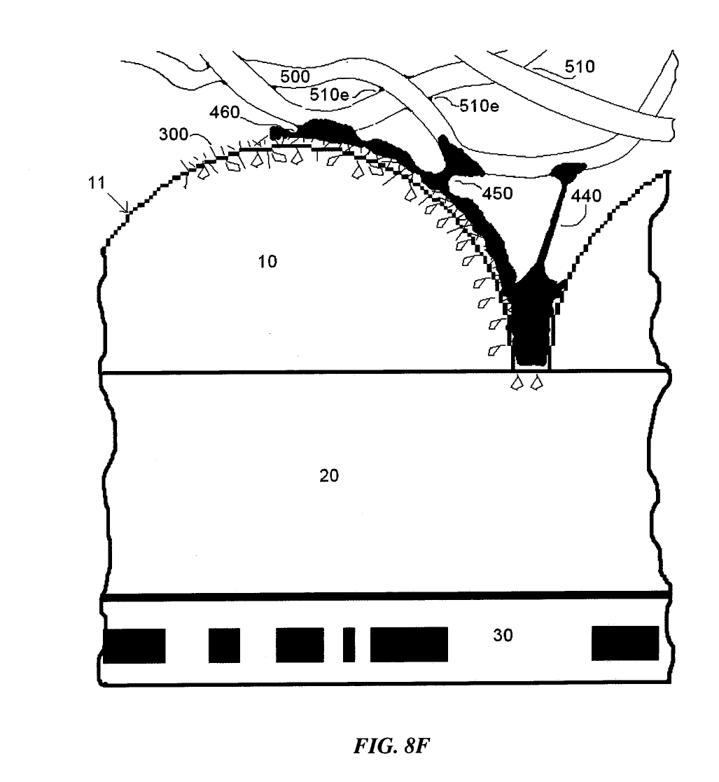

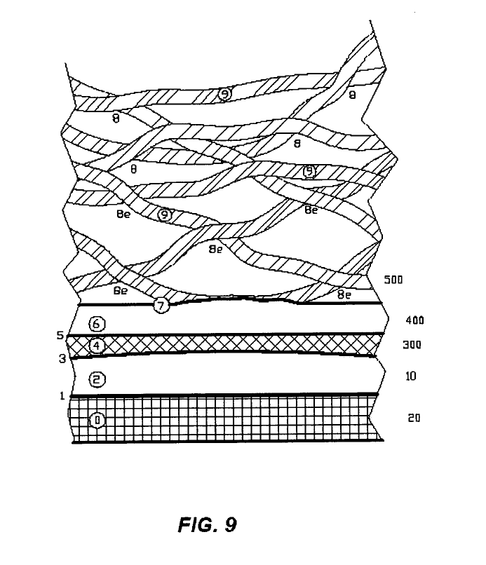

The largest area between the lenses is a concave triangle known in this application as the “meadow” [50]. The short valley does not pass through the meadow and the long valley passes through two meadows. As the lenses are “fattened up” by applying a system of conformal coatings—serving the dual purpose of adhesive and contact lens—the size of the meadow decreases. Additionally, the meadow can tolerate a thicker layer of adhesive than the lenses can without harming the optics. The thicker layer of adhesive in the meadow is somewhat useful for bonding the fiber network once the dried on adhesive is rewetted in the papermaking process. However, the dominant attachment zones are redistributed topside adhesive in a large contact radius as fibers lie across multiple lens tops as depicted by FIG. 8A through FIG. 8F.

In the present invention, plano-convex lenses with a high numerical aperture mean the microlens array can be an array of large spherical or aspherical sections on a planar carrier film. Under a microscope, the lenses appear to be hemispherical.

Lenses can be inorganic, organic materials fabricated by thermal reflow, or micro-replicated resins. The prior art is rich with many techniques for making microlens arrays. One purpose of the present invention is to coat any such microlens array at a later time than when it is fabricated. In some cases, the present invention can be applied in-line on a web-fed coating machine immediately after the microlenses are continuously fabricated.

### Traditional Lamination of Micro-Rough Surfaces

Traditionally, when two micro-rough surfaces require bonding with an adhesive, it is applied to one or both sides in an amount that fills the micro-roughness of both surfaces, while wetting and attaching to both sides. This approach can be accomplished with a single part formulation that solidifies in some sort of time-activated delay, or a multipart formulation with a delayed reaction time to allow for application and subsequent bonding. Whether the adhesive is activated by melting, through a two-part chemical reaction, moisture activation, or radiation curing, the traditional approach to laminating two micro-rough surfaces is to fill the voids, activate the adhesive and apply pressure. The adhesive system chosen is always directed by performance, cost, material constraints and process constraints.

### A-B Lamination

A special case of traditional lamination is called A-B lamination, in which an adhesive is first applied to one solid surface, and at a later time, another solid surface is brought into contact with the A stage adhesive bonding. Stage A refers to the application of the adhesive to the first surface, and stage B refers to the contacting of the two surfaces together at a later time with some sort of activation—heat, pressure, moisture, a solvent, UV or some combination of the above, known to one skilled in the art. Traditionally, A-B laminations of micro-rough surfaces use 15 to 50 microns or more of adhesive to achieve bonding. The adhesive of the present invention is constrained by optical requirements to be 1 to 3 microns thick applied to a microlens array in an A-B lamination with wet paper fibers in the papermaking process. In this case, the A stage is most preferably applied as the micro-optical films are made, before they are slit into narrow ribbons. The B stage is the unconventional process of introducing the adhesive coated security ribbon into the paper making process just as the paper sheet is consolidated. The present invention could also apply the adhesive and dry it onto the security ribbon just before it is inserted into the paper, but generally speaking, it is more practical to dry the adhesive on as the lenses are being continuously made.

Constraints that Define the Present Invention

In the present invention, there are several extreme constraints that rule out the use of prior art adhesives. The most notable constraint is that the adhesive must first be applied to the microlens array and solidified in a way that at least does not degrade the optical properties of the array, and most preferably would improve them. Closely examined, the microlens array has hexagonally close-packed plano-convex lenses with a high numerical aperture on a thin flexible transparent carrier film. To apply an adhesive onto this micro-rough geometry without degrading the optics requires not filling in the spaces between the lenses, which is the standard practice of the prior art adhesive strategy. Moreover, the adhesive must have refractive index properties which are compatible with the refractive index of the plano-convex lenses. If the space between lenses were to be filled, the average refractive index of the adhesive should be as close to that of air as possible, a very difficult constraint to meet. With great difficulty this could be achieved by dispersing nanoparticles of negative refractive index evenly in a polymeric adhesive with low positive refractive index. Such a strategy may work better for select light frequencies than others, because particles of negative refractive index are plasmonic structures that are size and frequency dependent.

More practically, the refractive index of the adhesive should be very similar to that of the microlens array that it coats and the adhesive should be coated in a way that closely conforms to the geometry of the lenses.

Whatever adhesive material is applied to the surface of plano-convex microlenses must not adhere in a sticky, accumulating manner to the parts of the papermaking machine that come into contact with the surface of the paper. This constraint alone rules out a simple, hot melt, thermoplastic solution because the drying section of a papermaking machine is hot and comes into contact with the paper surface. Thermo-plasticity within the adhesive is not a problem, but “sticky-when-hot” would be undesirable.

Numerous resins are available which might meet many of these and the following constraints, but they are emulsion polymers and may not fully coalesce and chain entangle in the course of their application and drying, thus leaving residual optical haze, or weak tensile strength. Emulsion polymers are a possible constituent of the present invention provided haze is kept to a minimum. Being the outermost optical layer for the final lens system, the present invention must be optically clear in thin films. Emulsion polymers sometimes have molecular weight distributions containing some small molecules, which in turn decreases tensile strength. If emulsion polymers are to be used, most preferably they will not contain low molecular weight species. This is true for reasons of ultimate tensile strength of the adhesive and because keeping constituent molecules very large is a good strategy toward non-toxicity.

Additionally, when coated onto the lens array, the adhesive coating, in its final solid form, must conform closely to the surface of the lenses in a thin conformal film, which does not touch the coating on neighboring lenses excessively. As such, the initial viscosity of the adhesive must be low so that the solids content is free to migrate to form a thin conforming coating. Hence, the solids content of the applied adhesive must be low enough upon coating so that, upon drying, the final film formed is thin relative to the lens spacing.

Many solutions to this problem of coating an optically clear, non-adhesive microlens array with an adhesive layer that also functions as a lens layer will require an evaporative solvent, most preferably water, or less preferably an alcohol, or still less preferably, a volatile organic solvent or a silicone solvent. Additionally, the surface chemistry of the adhesive solution must be such that as the solvent evaporates, the solid content of the adhesive spontaneously self-assembles into a conformal coating. Further, the adhesive coating, when applied, must never let go of the lens and, when inserted into the wet papermaking process, must bond with initially wet paper fibers that are moving and shifting as the paper is compressed, dewatered and dried under tension, all the while surviving the crushing forces of the Campbell Effect, which brings hydrogen-bonding fibers together with tremendous force as the water is evaporated in the drying section of the papermaking machine.

The above are the known constraints before a chemical solution was found. As those constraints were respected and a variety of solutions were attempted, a pattern of forced, de-lamination failure modes emerged which pointed the way to a preferred embodiment.

### The Preferred Embodiment Enables High Force for Delamination Failure

This embodiment is preferred because its forced failure mode requires the greatest de-lamination force and does not provide for a mechanism of localized fiber failure. It therefore has the greatest probability of long-term successful lamination before long-term age testing could be tried. In fact, the preferred embodiment produces a failure mode in which the forced de-lamination of the paper and adhesive-coated microlens array results in the microlenses themselves being de-laminated from the carrier film only with great force, not likely to occur in circulation of banknotes or other documents of value. Therefore, in the chain of connected interfaces between the carrier film [0][1][20], the lenses [1][2][10], the adhesive of the present invention [2][3][4][5][300][400] and the paper fibers [8][500], the bonding between the lenses and the carrier film [1] is the weakest link in the preferred embodiment. If this link were subsequently to be strengthened, the failure mode would change, but the utility of the preferred embodiment would not. Indeed some high force failure modes result in the lenses remaining attached to the carrier film and a think carpet of fibers remains attached to the lens top with a high force required that circulating documents of value would not experience.

### Some Defining Characteristics of the Preferred Embodiment

The primary foundation of the preferred embodiment contains eight key elements that, in turn, inform and define a family of chemistries capable of achieving that foundation. Those key elements are as follows:
1. A conformal primer [300] that tenaciously adheres to the micro-lenses, has high internal cohesion, and provides for unreacted moieties that can bond on contact with a subsequent adhesive layer.
2. A conformal adhesive second coating [400] that, upon drying, is relatively thick in the meadows between lenses and thin and conformal on the lenses, and is bonded tenaciously to the primer layer through co-reactant moieties, as well as short-range bonds. Some primers layers could function with only a high density of short range bonds such as hydrogen bonds and or Vander Waals bonds.
3. An adhesive formulation that is well bonded to the primer layer and swells sufficiently upon contact with water during the papermaking process (FIG. 2A) such that fibers pressed into near contact with the conformal adhesive are enveloped into and bonded with a substantial portion of the outermost adhesive layer. (FIG. 8A-F).
4. An adhesive formulation that, upon rewetting in the papermaking process, forms adhesive fibrils between the lens array base and any paper fibers that momentarily contact it during the papermaking process, most preferably with large contact angle radii with both the lens layer and the fiber layer. FIG. 8F [460] [450] [440]
5. A zone of reinforced fiber-to-fiber bonds in the near vicinity of the security thread created by ejection of a small portion of the adhesive into the fibers while under compression that leads to strengthening of the near proximal fiber-to-fiber bond. [510e]
6. The outermost adhesive layer must behave in accordance with the above-described characteristics and have high tensile strength upon drying during the papermaking process. High tensile strength is defined as a tensile strength higher than the fiber-to-fiber bond strength and higher than the lens-to-carrier-film bond strength. A subsequent increase in the lens-to-carrier-film bond strength will change the failure mode, but will not require an increase in the adhesive tensile strength. (FIG. 9, [6], [7], [8], [5],[4],[3],[2],[0]>[1] When the tensile strength of the topside adhesive and all related interfaces are greater than the bond strength between the lenses and the carrier, the forced delamination mode is to remove the lenses from the carrier with great force.)
7. The outermost adhesive layer must have a refractive index that is close to that of the microlens material or higher, not accounting for any anti-reflection coatings that employ diffractive or nano-scale techniques.
8. The adhesive layer must be optically clear as a thin film with respect to color and haze. Color and haze in a thick film of this material is not relevant.

### Definition of OML-01

For the purposes of describing the solution containing layer 1 in general, which, upon drying, is in direct contact with the lens layer, no matter what specific formulation is used, it will be called OML-01. The solution containing first layer adhesive solids referred to as OML-01 may be a single solution or may be stored in separate parts and pumped and mixed together just before being applied to the surface of the micro-optical film. The optionally separate parts can be referred to as OML-01A, OML-01B, OML-01C and so forth.

### Definition of OML-02

For the purpose of describing the solution containing layer 2, which, upon drying in a two layer adhesive formulation, is in direct contact with the fibers, no matter what specific formulation is used, it will be called OML-02.

The solution containing second layer adhesive solids referred to as OML-02 may be a single solution or may be stored in separate parts and pumped and mixed together just before being applied to the surface of the micro-optical film. The optionally separate parts can be referred to as OML-02A, OML-02B, OML-02C and so forth.

### The Chemistry of OML-01 Depends on the Lens Material

At least three families of chemistry are capable of achieving the goals of the preferred embodiment with respect to the primer layer (OmL-01):
1. For inorganic microlenses, organo-tri-silane modification and silane crosslinking with pendant organic ligands for reaction with the second adhesive layer
2. For organic microlenses, there is a rich body of art for priming the surface with well anchored monomers, oligomers or polymers that leave a residual amount of un-reacted moieties ready for co-reaction with a subsequent second adhesive layer.
3. A reformulation of the lens chemistry that would insure the presence of unreacted moieties on the surface of the microlens such that a primer layer is not required

For inorganic lenses, the prior art, which consists of organo-silane surface modification, is sufficient. Commercially available organo-trisilanes can be hydrolyzed in a dilute solution of water in mostly alcohol, such as ethanol or isopropanol, pH adjusted with acetic acid to around 4.0. After rapid stirring for about 30 minutes, the hydrolyzed silane solution can be wiped on and dried to render the underlying lenses well bonded with a crosslinked layer rich in organic moieties ready for reaction with the subsequent layer. One specific example is epoxy tri-ethylsilane. Another example is trimethylsilane-monomethacrylate.

Even though the prior art is rich in primer chemistries for polymers, for the specific geometry and chemistry of organic lenses, the prior art is not adequate. To achieve adhesion to organic lenses, high cohesion within the primer and to retain a high density of unreacted moieties, the preferred embodiment follows: A dilute solution of high molecular weight polymers is wiped onto the lenses and dried. These high molecular weight polymers have a refractive index that is compatible with the coated lenses. The refractive index matters less if the layer is very thin. If its thickness is a significant fraction of the wavelength of light, the refractive index should closely match that of the lens. Alternatively, the refractive index can be intentionally lower than the lens for reasons that will be described later. Additionally, polymers of primer layer 1 have a rich density of unreacted side groups onto which small molecules can be reacted as side chains. These reacted-on side chains include moieties which solvate the underlying lenses for improved adhesion or react with the still-reacting lens chemistry. These high molecular weight polymers are selected so that the unreacted side chains serve as the moieties required to covalently react with the subsequent adhesive layer, and for their ability to self crosslink. The high molecular weight polymers of layer 1 are also selected for their high tensile strength.

One example of such a high molecular weight polymer with a high refractive index is Polycup 7360 from Ashland Chemical, which is chemically similar to nylon and has a refractive index of 1.53. Polycup 7360 is a linear polymer rich in azetidinium rings as unreacted side chains. It is a PAAE class of wet strength resin. The azetidinium ring side chains will react with carboxylic acid (slowly at elevated temperatures), sodium carboxylate (rapidly at elevated temperatures), sodium sulphonate (rapidly at room temperature), or primary amines (slowly at room temperature) within the secondary adhesive layer, or under alkaline conditions, with themselves. Another example of such a high molecular weight polymer with a high refractive index is polyvinyl alcohol modified with acetoacetyl side chains, such as Z-410 from Nippon Gohsei, Japan, or their other Z class PVOH molecules. The Z class of modified PVOH will react with primary amines in the secondary adhesive or with itself under acid conditions. A third example of a high molecular weight polymer with a lower refractive index is activated Kymene from Ashland Chemical. It is rich in epoxy ring side chains, once activated, which also react with carboxylic acid, sodium carboxylate or primary amines within the secondary adhesive layer. These resins are activated PAE wet strength resins: They self crosslink under alkaline conditions.

The above-mentioned linear polymers can be modified by reacting-on mono-amine side chains that serve the dual purpose of promoting adhesion with the primary lens and slowing down reaction kinetics with the remaining unreacted sites-such as azetidinium, epoxy or acetoacetyl. Kinetically, to modify PAAE resins, a mono-sulphonate more rapidly will attach as a side chain compared with a mono amine.

The reacted-on side chains that promote adhesion with the base layer also retard reaction kinetics with a second class of high molecular weight polymer. This second class of high molecular weight polymer primarily serves as a cross-linker for the first class of high molecular weight polymer while reacting slowly and promoting adhesion with the base lens. This second class of high molecular weight polymer also has a high density of unreacted side chains.

An example of such a second class of high molecular weight polymer is polyvinyl amine, which is rich in primary amine side chains. It can easily be modified with monoacrylates, monomethacrylates or monoepoxides to increase steric hindrance, thus slowing reaction kinetics of its residual amines, and improve adhesion to the base microlenses by selecting adhesion-promoting side-chains to serve the dual function of adhesion promotion and steric hindrance. It is not required that the crosslinker for the first class high molecular weight polymer be of a high molecular weight. However, a high molecular weight crosslinker is preferred for both mechanical reasons and toxicity reasons provided the co-reaction kinetics are slow enough that dilute solutions of the two classes of polymers can be pumped and mixed together just before being coated on without globules forming.

Regarding the two classes of polymers that can be side-chain modified and co-reated, with or without a non-reacting diluent polyer(s), “various amines, enolates, thiols and phosphines can react with (meth)acrylates, (meth)acylamides, maleimides, acrylonitriles and cyanoacrylates, which are Michael donors and Michael acceptors, respective” from Investigation into thiol-(meth)acrylate Michael addition reactions using amine and posphine catalysts. Polymer Chem, 2010 7 Jun. 2010, by Li et al. Add to the list of Michael acceptors epoxides and azetidinium rings.

Moreover, it is not required that either class of high molecular weight polymer be linear. Branched polymers, and even dendrimers, have been demonstrated to work provided they are firmly affixed to the lens surface, contribute to or do not disturb the optics of the base lens, and provide a rich set of sites for bonding on the subsequent, fiber-attaching adhesive layer. Low molecular weight polymers having a combination of lens solvating and/or reacting groups together with residual groups available for subsequent reaction with the secondary adhesive have been shown to be effective in layer 1. However, for purposes of low toxicity and tensile strength, it is preferred to keep the molecular weight of the topside adhesive formulation high.

### Adhesion Promoting Side Chains for OML-01

The adhesion-promoting side chains, reacted onto a polyamine such as polyvinyl amine, may include tetrahydrofurfuryl acrylate in the case of the second class of high molecular weight polymer, and tetrahydrofurfuryl monoamine in the case of the first class of high molecular weight polymer. Additionally, a primary alcohol-mono acrylate such as epsilon caprolactone monoacrylate (for reaction with a polyamine) or a similar primary alcohol-monoamine (for reaction with the first class of high molecular weight polymer) provides a primary hydroxyl group for reaction with the lens chemistry. Ethoxylated side chains also promote adhesion and lower the glass transition temperature of the primer layer, allowing the layer 1 crosslinking to continue after heating and drying ceases.

Even though these two classes of high molecular weight polymers react with each other, the solution is so dilute and the rate of reaction is so retarded by a controlled amount of steric hindrance that these two classes of polymers can be mixed together just before the dilute solution is coated onto the microlens array. In this way, as the solvent evaporates, the polymers come closer together and begin to co-react and or self-crosslink. Their adhesion-promoting side chains dig into the surface of the substrate microlens and the residual unreacted moieties are available for subsequent reaction with the second adhesive layer. Additionally, some of these side chains are chosen so they will react with the lens chemistry.

These two classes of high molecular weight polymers are not added in equal amounts. The polymers with a high density of moieties for subsequent reaction with the second adhesive layer are added in the majority, and the second class of high molecular weight polymer (or slow crosslinker in general) is added in the minority. Where adequate self-crosslinking and lens adhesion in the first class formulation is demonstrated, the second class is not required because its primary purpose is to promote lens adhesion and build molecular weight through slow crosslinking with the first class.

Additionally, when these high molecular weight polymers are modified with adhesion promoters, which co-function as kinetics retarders through steric hindrance, a “bottlebrush” polymer is formed. Most high molecular weight linear polymers fold and bend like spaghetti noodles. Bottlebrush polymers, however, are much stiffer and straighter, although they can bend to curved surfaces. Bottlebrush polymers with the right balance of side chains, as in this preferred embodiment, form an excellent surface-conforming layer that can be tuned according to different surface chemical side chains reacted onto the main chain. The preferred embodiment for both layer 1 and layer 2 is not a monolayer. They can be as thick as they need to be for adhesion and optical purposes in a single coating. The use of blends of high molecular weight polymers, some of which co-react at a hindered rate enables coatings with controllable thickness to be applied in a single pass.

In both the inorganic and organic microlens cases, the resulting primer layer is a macromer that is thin and conformal to the lens surface. The macromer is well penetrated into the lens surface through solvation and/or reaction with the lens chemistry, while presenting a rich density of well anchored yet unreacted moieties which are available for subsequent reaction with the second adhesive layer. When they are used, it is important to balance the selection of bottlebrush polymers in OML-01 to include a significant amount of hydrogen bonding groups. By enriching layer 1 with hydrogen bonders and reactive moieties designed for co-reaction with layer 2, the primer layer makes an important transition from the lens chemistry to one that is more similar to the fiber chemistry. As a result, layer 2 has fewer design requirements and can be focused on fiber adhesion. For this reason, it is advantageous to include wet strength resins of appropriate refractive index within the formulation of OML-01.

Another OML-01 candidate is functionalized polyvinyl alcohol with acetoacetyl side chains. Moderate to high molecular weight PVOH can have a high tensile strength and high refractive index when highly hydrolyzed, is self crosslinking under acid conditions, is rich in hydrogen bonding hydroxyls, and provides for unreacted acetoacetyl side chains for subsequent reaction with the second adhesive layer. A minority of the acetoacetyl side chains can be reacted on with mono-amines to add adhesion promoters and to create a bottle brush conformation.

The prior art for microlens arrays also has an intermediate case in which inorganic nanoscale ceramics are blended with organic components to increase the refractive index of the microlenses. The formulations and approaches for topside adhesive can be adjusted for this intermediate hybrid case of inorganic and organic lens materials. Specifically, the first adhesive layer may require a blended dilute solution of hydrolyzed organo-silane chemistries and bottlebrush polymers, which are self-crosslinking and designed to conform and adhere to the lens. In this intermediate case, the two classes of chemistry blended in the first adhesive layer form an interpenetrating network. Alternatively, one may react an amino-trisilane onto amine reactive polymers that are modified to adhere with the organic components of the lens chemistry. For example, PAAE wet strength resins, activated PAE wet strength resins, or acetoacetyl functionalized polyvinyl alcohol, can be modified with mono-amino-trisilanes in addition to the other modifications listed above for the organic lens case.

Lenses of high numerical aperture are covered with self-crosslinking polymers with solvating or fast reacting side chains. As the polymers crosslink during evaporation of the carrier solvent and heating of the micro-lens film, subsequent lifting forces from the attached fibers (joined to the second layer adhesive) distribute the lifting force to the entire first layer that is capped onto the dome-shaped high numerical aperture lens. The solvating side chains act like spurs into the side of the primary lens, while the self-crosslinking and co-reacting nature of the first coat creates a transparent grafted-on contact lens cap. More preferably, unreacted species within the polymeric lens material will be matched by complementary unreacted side chains of the first adhesive layer. For those lens compositions that are cationically cured, the reactive species of the first adhesive layer can be primary alcohols which react rapidly with cycloaliphatic epoxides or other epoxide types. A delayed reaction results from tertiary butyl acrylate side chains reacted onto primary amine groups of a polyvinyl amine within the first layer adhesive. Tertiary butal acrylate, Michael Addition reacted onto polyvinylamine, will hydrolyze under cationic conditions to reveal a butanol that volatilizes with the first layer carrier solvent, and leaves behind a carboxylic acid group bound as a side chain to the polyvinyl amine. Under cationic conditions and the elevated temperatures of the drying process, carboxylic acids react rapidly with epoxides, glycidyls, and cycloaliphatic epoxides. The advantage of using tertiary butylacrylate as a side chain is that it is initially hydrophobic and a good solvator of the lens surface. Once inside, as the butanol hydrolyzes away, the resulting carboxylic group forms a covalent bond with any available epoxide groups. It therefore is both a solvator and a reactor.

Within layer 1, polyvinyl amine is a good main chain crosslinker when populated with lens penetrating side chains and side chains with delayed reactive capacity, such as tertiary butyl acrylate or primary hydroxyl side chains (epsilon caprolactone mono-acrylate). One excellent example of a lens-penetrating side chain through solvation is tetrahydrofurfuryl acrylate (THFA) that is Michael-Addition reacted onto primary amine side groups of polyvinyl amine. In addition to having much of the solvating power of terahydrofuran, the secondary-amine reaction product of THFA and polyvinyl amine leaves strong hydrogen bonding THF groups that are capable of hydrogen bonding with hydroxyl, amine and carboxylate species from the layer-2 formulation as well as solvating the layer 2 polymers in general. BASF provides polyvinyl amine which varies from 10% to 95% primary amine side groups. For these purposes, 95% works best.

Another component that has good refractive-index compatibility with the plano-convex lens, excellent hydrogen-bonding capacity, high molecular weight, self-crosslinking ability under cationic conditions and amine-reactive capacity is polyvinyl alcohol with acetoacetyl side groups. Commercially available examples are Z-410 or Z-200H from Nippon Gohsei of Japan. The hydroxyl side groups of polyvinyl alcohol, when in a sterically fortunate configuration, can react with glycidyl, epoxide or cycloaliphatic epoxides from the lens surface under cationic conditions. The acetoacetyl side chains of modified PVOH are amine-reactive and are available for subsequent covalent bonding with primary amine species from adhesive layer 2. Acetoacetyl side groups are self-crosslinking under cationic conditions.

Yet another component that can be co-blended into a dilute solution of the layer 1 adhesive is a PAAE resin. PAAE resins have a high refractive index, near that of Nylon 6 (polycaprolatam) n=1.530, which is very similar chemically to PAAE resins, and the azetidinium ring side groups provide reactive sites for two different sources of primary amine: Partially substituted polyamines can be used effectively within the first layer and partially substituted polyamines are preferred within the second layer. An example within the first layer is a crosslinker/adhesion promoter composed of polyamine-substituted THF-acrylate (THFA), eplison caprolactone monoacrylate and tertiary butyl acrylate. Both the azetidinium side groups of the PAAE resin and the acetoacetyl side chain of the modified polyvinyl alcohol will react at a slow kinetic rate with polyvinyl amine that is heavily substituted with side chains of THFA, tertiary butyl acrylate, ring opened epsilon caprolactone mono-acrylate, and optionally, short ethoxylated chains. PAAE resins are also reactive with carboxylic acid groups that are formulated into the second adhesive layer, more specifically, carboxylated polyvinyl alcohol within the second layer adhesive and mono-acrylate-caboxylate reacted onto a minority of amine groups of the polyvinylamine of the second layer.

In one embodiment:

Heavily substituted polyvinyl amine takes on a bottlebrush configuration which can result in a helical conformation. Even a heavily substituted bottlebrush polyvinyl amine has residual primary amines available for reaction with azetidinium rings and acetoacetyl side chains, within OML-01. Additionally, each mono-acrylate substitution onto a primary amine site of polyvinyl amine results in a residual secondary amine. After formation of the THFA/teriary butyl acrylate bottlebrush polyamine (with optional primary hydroxyl from epsilon caprolactone monoacrylate), which is added in minor components of 20% or less of total solids of the first layer adhesive, the PAAE resin and acetoacetyl-modified polyvinyl alcohol are added, in total as 9% or less solids concentration relative to the water solvent. Mixed in a batch or more preferably pumped through a continuous inline mixer, the increasing viscosity is evidence that the polyamine bottlebrush has sufficient residual amine and sufficient steric opportunity to knit together the entangled PAAE resin and acetoacetyl modified PVOH to form a loosely knit, high molecular weight network that is ready to penetrate the surface of the plano-convex lenses with spurs of THFA side chains and tertiary butyl secondary-amino side chains. Additionally, the polyelectrophiles of layer 1 may be partially substituted with mono-amines, which promote adhesion or react with the primary polymeric microlens. Such substitutions include, but are not limited to, diglycol amine, tetrahydrofurfuryl amine (THF-amine), and primary hydroxyl-monoamines.

In the case of cationically cured lens chemistry:

To insure that residual amines from the bottlebrush substituted polyamine (such as polyvinyl amine) do not poison the reactive chemistry of the primary lens, the blend of transparent, water-soluble, high refractive index, partially substituted polyelectrophiles (such as PAAE resin or PAAE blended with activated PAE resin or acetoacetyl substituted polyvinylalcohol) and heavily substituted polynucleophiles (such as polyvinyl amine), can be further blended inline just prior to coating the solution with a dilute aqueous solution of a cationic catalyst, for example zinc triflate, or a milder sulphonic acid. The purpose of this final blending and inline mixing is to neutralize the residual amines on a stoichiometric basis and to have just barely enough excess to have a cationic resin upon drying. Cationic conditions give rise to self-crosslinking among acetoacetyl side chains on the polyvinyl alcohol. Cationic conditions also suppress self-crosslinking amongst the azetidinium side groups of the PAAE resin. The net result is the key purpose: Many adhesion promotion side groups, a high molecular weight which is loose and open upon application and significantly increases crosslink density upon drying, yet possessing residual electrophilic groups or acetoacetyl groups that await reaction with the nucleophile-rich second coating. A cationic catalyst in layer 1 also helps to restore the continued cationic reactivity between the primary lens and the layer 1 chemistry when epoxides and the like are used in the lens chemistry.

After layer 1 is coated and dried to a solid equivalent to a doctored-on solution at 0.5% to 9% solids, layer 2 is applied and dried. These percentages assume that the application method is a smoothly polished coating bar wiping the solution across the tops of the primary lenses. If other coating methods dispense more or less solution per unit area, the solids content should be adjusted accordingly.

### Chemistries Useful for OML-01 and OML-02

At least two families of chemistry are capable of achieving the goals of the preferred embodiment with respect to the second adhesive layer. These are custom copolymerization of monomers or oligomers, and custom monomer or oligomer addition to reactive polyfunctional polymers.

### Custom Copolymerization

One approach to achieving all of the above constraints in a water-soluble second adhesive layer is to copolymerize several monomers, which together impart the combined characteristics described in the preferred embodiment. This approach can be taken as a single polymer or as several polymers that are blended together, some of which may be commercially available polymers co-blended with novel polymers. For the outermost adhesive layer to migrate and self-assemble into a lens-conforming layer, the initial viscosity must be low while still maintaining a high enough solids content in the coated-on solution to achieve the geometric and non-geometric goals of the preferred embodiment, in the minimum number of coatings. If a single high molecular weight polymer is used, multiple coatings are required to achieve the same adhesive performance as the preferred embodiment because the high molecular weight boosts viscosity and multiple dilute coatings must be applied. For that reason, a lower number of coatings can more preferably be achieved by blending at least two co-reactive polymers of moderate molecular weight that are sterically hindered to slow their co-reaction until the solution has been coated on and has begun to dry. This strategy enables an initially low viscosity with relatively high solids content to be successfully coated on in a conformal layer with a minimum number of coating steps. Two (or more) component systems are tuned in their steric hindrance to be able to blend them inline just before coating. In such a multi-component, blended system, it is preferable to keep the volume of adhesive solution in the post mix system to a minimum so that non-uniform viscosity-build does not occur over time as mixed-together adhesive recirculates in the coater. For this reason, and for reasons of precision coating across the web width, a slot-die coater can be advantageous. Other coating methods such as Meyer rod coating, reverse roll coating and coating by printing techniques are possible.

Using the custom polymerization paradigm for the layer 2 adhesive, some monomers contribute a high refractive index, while others provide rewetting swellability and water solubility. Still other monomers provide side chains of co-reactants that bond with either the first primer layer or paper fibers coated with wet strength resins. Hydroxyl side chain monomers are good for high refractive index with a maximum of about 1.55, hydrogen bonding, water solubility and, to a lesser extent, rewettability and swellability. Carboxylic acid side chains are good for wet tack, rewettability and swellability, and serve as a co-reactant with azetidinium side chains found in PAAE wet strength resins, as well as activated epoxide rings found in PAE wet strength resins. Aromatic side chain monomers contribute a high refractive index, but are hydrophobic and cannot be tolerated in high concentrations. Amine side chains provide good water solubility and good reactivity with a wide range of co-reactants, but they tend to depress refractive index and would be reactive with ethelenically unsaturated monomers or oligomers. Short water-soluble side chain monomers with low glass-transition temperature tend to improve lens conformity. Two examples are ethoxylated side chain monomers or polyethylene glycol side chains monomers. Ring opened, epsilon caprolactone side chain monomers also contribute to good lens conformity and provide a highly reactive primary hydroxyl for those systems that are able to co-react, such as various epoxides (cyclo-aliphatic epoxides and oxirane rings) and aldehydes commercially available as glyoxal resins. Resins containing formaldehyde are not permitted in most banknote papers of the world, so glyoxal resins used in this formulation must be formaldehyde-free.

The primary disadvantage to the custom polymerization paradigm is the time and expense of creating separate iterations in development and the relatively high capital cost required to control atmosphere, temperature and pressure during the polymerization process. Additionally, many polymerizations produce a broad distribution of molecular weights, and a fraction of the low molecular weight species are often detrimental to cohesion because they lower the tensile strength of the ultimate adhesive layer. For those polymerization processes which have better control of molecular weight distribution, such as anionic living radical polymerization, this paradigm may be the lowest cost path to the present invention, especially in high-volume production.

### Addition Customization of High Molecular Weight, High Refractive Index Polymers

However, a much faster path to an affordable solution is through the same family of chemistries used for OML-01, enabled by addition modification of commercially available high molecular weight poly-nucleophiles with commercially available low molecular weigh mono-electrophile side chains. Conversely, high molecular weight poly-electrophiles can be customized with many different types of lower molecular weight mono-nucleophiles. The same strategy can be applied to commercially available functionalized polymers that are neither nucleophile nor electrophiles, but have reactive side groups to which commercially available smaller molecules can be added. For example, acetoacetyl-functionalized polyvinyl alcohol can be modified with mono-amines, such as ethoxylated mono-amines or tetrahydrofurfuryl mono-amine. When coreacted with acetoacetyl-modified polyvinyl alcohol or PAAE resins or PAE resins, a pendant THF group is both a good hydrogen bonder and provides excellent solvation of most hydrocarbon systems, such as a polymeric microlens or a wet strength resin system using PAE or PAAE resins, either one of which coat the paper fibers.

A further advantage of the addition customization strategy is the lack of separations required when fewer small molecules are added as side groups relative to the high density of co-reacting side groups on the main chain, thus eliminating a routine waste stream. The high ratio of reactive groups on the main chain compared with the reactive groups on the modifying monomer side chain means that with sufficient mixing, time and temperature, all the small molecules will be consumed as they are addition-reacted onto the main chains as side groups. Hence only very large molecules remain, and even these may be crosslinked together with their co-reactants in the whole system. To preserve the advantageous high molecular weight, and consume all of the small molecules that are reacted-on, care must be taken not to shear the solution when it is being mixed. However, considerable mixing is required to make all the small molecules react on. A low shear, high volume vortex pump is advantageous for this purpose to re-circulate batches of grafted on bottle-brush polymers and their constituents. Additionally, care must be taken to avoid homopolymerization of the grafted on monomers, which can occur at temperatures greater than 50 degrees C. for acrylates and methacrylates. Conducting the addition reaction at lower temperatures and using low shear, high volume pumping will in time allow all the monomers to be grafted on. FTIR spectra can be used to determine that the monomers have been consumed and the low shear recirculation process can be continued for some additional time to eliminate undetectable amounts of monomer.

Irrespective of which strategy is applied, a blend of customized polymers and commercially available polymers can be delivered through metered pumping continuously and mixed together either through static mixing or dynamic motorized mixing just prior to coating onto the microlens array. For the layer 2 adhesive, to further retard the co-reaction between these inline mixed polymers, each coreactant can be blended with a polymer that contributes other desirable properties, such as high refractive index and very slow reaction with layer 1 or the wet strength resins. These blends of coreacting and non-coreacting polymers, if sufficiently sterically hindered, will delay the build-up of viscosity such that the blend can be pumped and coated onto the microlens arrays, inline as they are being mixed, and subsequently dried into a conformal coating. Care must be taken to avoid excessive crosslinking between the blended polymers to enable subsequent swelling, rewetting and extended fibril formation with momentarily contacted fibers under compression during the paper making process. FIG. 8 shows the result of three different cases of the fibers which come into intimate contact with the secondary adhesive, first in the swollen, rewetted state and shown in FIG. 8 after drying.

In the preferred embodiment, the key strategy to successfully using these polymers though addition customization is to create eleven characteristics with very few customizations:
1) Steric hindrance of co-reactants to produce low kinetic reactivity, thereby allowing low viscosity solutions to be coated on and dried before the viscosity begins to build
2) Residual reactivity with the paper wet strength resin or fibers and reactivity with the lenses
3) High refractive index
4) Optical clarity
5) Water solubility
6) Water swellability
7) High wet adhesion with wet paper fibers, including those coated with wet strength resins
8) Lens conformance with a thin coating of adhesive on the lenses and a thicker layer in the meadows
9) Wet elastomeric character or wet lyotropic character for fibril formation, most preferably balanced with all aspects of the system for large contact radius fibrils.
10) Low glass transition temperature and reactivity with wet strength resins for wet strength resin synergy.
11) High dry tensile strength in both the fiber embedded mode and the adhesive fibril extended mode

The high refractive index is largely achieved by starting with a high molecular weight, high refractive index, polyfunctional polymer and not adding too many low refractive index small molecule side chains. Examples include high molecular weight, high hydrolysis polyvinyl alcohol with acetoacetyl side chain functionality and PAAE resin with azetidinium side chain functionality. PAAE resins have a high refractive index and high tensile strength. They are easily modified by adding sulfonate monomers or, less preferably, amine monomers as side chains reacted onto the high density of azetidinium rings along their length. Similarly PAE wet strength resins are water soluble, and can be modified with amine monomer either before or after activation with sodium hydroxide solutions. PAE resins have a lower refractive index than PAAE resins.

Another useful polyfunctional high molecular weight main-chain polymer, useful for addition customization in the present invention, is polyvinylamine. The refractive index for this polymer is not high, but it is easily customizable with additions of low molecular weight mono-electrophiles which impart all of the desired characteristics except high refractive index. Once modified, it can be blended with other polymers which do have a high refractive index, for example high hydrolysis polyvinyl alcohol with carboxylate functionality or polyacrylic acid without too many sodium salts. Sodium salts of carboxylics acid increase viscosity and limit the amount of solids that can be deposited in a single conformal coating. Therefore, when polymers having a significant concentration of carboxylic acids are used, a trade-off can be made as to the percentage of acid groups which are salted out with sodium, an excellent catalyst for carboxylate reaction with wet strength resins. More sodium salts speed the reaction with wet strength polymers but quickly raise viscosity and fewer sodium salts allow for more solids but slow reaction with wet strength resins. While polyacrylic acid is water soluble, has high refractive index (1.53) and has good rewettability and wet tack, its tensile strength is lower than that of polyvinyl alcohol. When used in high concentrations, polyacrylic acid coagulates with amines and prevents a conformal coating. Polyacrylic acid is often used as a super absorbent in baby diapers and is considered non-toxic (as is polyvinyl alcohol). Polyacrylic acid can be used as a minor ingredient for formulating the present invention but is not required for the preferred embodiment.

Water solubility together with non-toxicity is achieved by using water-soluble high molecular weight polyfunctional polymers and adding mostly water-soluble side chains. Water swellability is inherent to amine groups and carboxylic acid groups. Side-chain modified polyvinyl amine blended with carboxylated, high hydrolysis polyvinyl alcohol has inherent water swellability, especially when the side chains grafted onto polyvinyl amine are water-soluble chains, such as mono-acrylated ethylene oxide chains or mono-acrylated carboxylic acid chains, such as Sartomer SR-147.

High wet adhesion with wet paper fibers is achieved through high concentrations of amines and carboxylates or carboxylic acids, as well as sulphonates. The articles of Li and Pelton are instructive in this area, such as, Enhancing Wet Cellulose Adhesion with Proteins, published in Ind. Eng. Chem. Res., 2005, 44 (19), pp 7398-7404, and is incorporated by reference in its entirety. Additionally, finding the matching balance of hydrophilic and hydrophobic character between the adhesive formulation and the wet strength resin-modified paper fibers improves wet-paper-fiber wetting and adhesion. When adding a small minority of hydrophobic side chains to bring the hydrophilic-hydrophobic balance into better match, it is advantageous to use hydrophobes that have good short range bonding characteristics such as Vader Waals bonding. For example, polyvinyl amine can have a small minority of tert-butyl acrylate added on because small hydrocarbon clusters form good short range adhesive bonds, whether wet or dry. Because matching the hydrophobe to hydrophile ratio between surfaces improves wetting of the two surfaces, the preferred embodiment uses hydrophobes that have good short range bonding characteristics such as the previous example.

Recently, wet paper fibers have been found to adhere well to several different polypeptides, so water swellable polypeptide chains are a valid component of the layer 2 adhesive, especially when the refractive index is high. Additionally, polypeptides with a tri-helical conformation similar to collagen have been found to have a high refractive index, 1.54, and a very high tensile strength. These too are a valid component of the layer 2 adhesive but are not required.

Generally, for high adhesion to wet paper with a high tensile strength, polyvinyl amine is excellent. Side chain modified polyvinyl amine is excellent for satisfying multiple requirements of the present invention, especially dried-down contact lens shape.

Microlens conformation (upon drying) is enhanced and steric hindrance is enabled by the formation of bottlebrush polymers by adding a significant minority percentage of side chains to the short reactive side-groups of polyfunctional main chain water-soluble polymers. Additionally, high refractive index water-soluble elastomers result from the bottlebrush polymers that begin as high refractive index main chain polymers and have water-soluble side chains added. These relatively stiff bottlebrush polymers are free to bend over the curvature of the lens, and yet tend not to coil in the spaghetti-like fashion of straight chain flexible polymers. The tendency toward lens conformation is a balance between the residual reactivity of the original main chain, the surface chemistry of the added side groups, and to some degree the application and drying dynamics of the coating process. For the most part, lens conformation is accomplished through the surface chemistry of the co-blended bottlebrush polymers and co-blended water soluble linear polymers.

Bottlebrush polymers, when highly substituted, have a helical character that make good optically clear elastomers when lightly crosslinked into a network. Unlike polyurethanes, which have separate stiff sections and random coiling sections that tend to phase-separate and cause light scattering, helically conformed bottlebrush polymers do not undergo phase separation and hence tend to be clear and non-light-scattering in the dry state.

When two coreactive bottlebrush polymers are mixed inline just before coating the microlenses, a controlled amount of crosslinking can occur that allows the network to form strong, wet-extensible fibrils when the adhesive coated film is inserted into paper. The side chains provide enough steric hindrance that crosslinking does not substantially occur until during and after drying. Crosslinking can also occur between one bottlebrush polymer and a non-bottlebrush crosslinker. The lengths of the side-chains of the bottle brush polymers can be tuned for multiple purposes. Short side chains that are significant in there density along the main chain make the polymer fatter and stiffer but do not chain entangle with other polymers in the formulation. Longer side chains do chain entangle with the rest of the formulation and can help with the formation of large radius fibrils. In the wet state, the bottle brush polymers which are part short chains and part long chains, loosely crosslinked into a network that is interpenetrating with high tensile strength, high refractive index hydrogen bonding polymers will help guide the high tensile strength polymers into a high contact radius fibril, especially when the branched polymer network has been customized for wetting and reactivity with the wet fibers.

A further technique for slowing the rise of viscosity associated with crosslinking is to blend the two co-reactants in a high refractive index, water swellable polymer such as highly hydrolyzed, carboxylated polyvinyl alcohol. Both steric hindrance and polymer dilution are used to slow the rate of crosslinking, thus keeping the viscosity low during coating. The high refractive index of highly hydrolyzed polyvinyl alcohol also compensates for the lower refractive index of modified polyvinyl amine. After the coating is applied and the film is later inserted into paper, the branched polymer network guides the deformation and elongation of the swollen, high tensile strength polymers which are only strong when dry.

When these blended solutions are being coated, if the coating line needs to temporarily stop, the tubing supplying the blended components, as well as the inline mixer, can be flushed with water to avoid a viscosity build-up during the coating line stoppage. Very brief stoppages would not require flushing the lines because the mixed solution viscosity increases though crosslinking mostly upon drying and slowly with time in the wet state.

Low glass transition temperature side chains serve three purposes.
1. First, they depress the glass transition temperature of the overall adhesive, thereby allowing the two co-reacting bottlebrush polymers (or one bottlebrush with a non-bottlebrush crosslinker) to continue reacting with each other after application and drying onto the microlens surface to a full high tensile strength elastomeric network. The extent of crosslinking is such that this network is extensible when wet and stronger and stiff when dry. However, the hydrogen bonding of the high tensile strength, majority polymer will prevent extensive long range chain mobility.
2. Secondly, bottlebrush polymers with low glass transition temperature side chains that are not fully crosslinked into the network are ejected under compression and will penetrate the fiber mat in close proximity to the adhesive. These ejected molecules both react with the wet strength resin and depress the glass transition temperature of the wet strength resin. A co-pending application describes a class of polymers that can be used to add to the overall wet strength of PAE and PAAE wet strength resin papers by depressing the glass transition temperature of the system, which lets a substantially incomplete reaction achieve a far higher crosslink density and ultimate strength. Also, by providing additional material to the fiber-to-fiber attachment points, the radius of curvature and total material content of the fiber-to-fiber contact point increases and stress concentrations thereby decrease. Boosting the fiber to fiber bond strength in the near vicinity of the adhesive prevents un-entangled paper fibers from acting like a release layer. It also changes the failure mode of detachment between the lens array and fiber sheet to a much higher energy failure mode; a primary goal of the present invention. The outer surface is less subject to detachment of unentangled fibers because the paper size performs largely the same function from the outside of the paper, inward as far as the size penetrates. But the under side of the fiber bridge that is in contact with the lens array does not have full access to paper size material. For this reason, it is important to formulate the adhesive in the present invention to strengthen the paper from the inside-out, without reducing the porosity of the paper.
3. Low glass transition temperature side chains help the loosely crosslinked network of wetted polymers to pool in the meadows between the lenses leaving a thin conformal coating on the lenses, reacted onto the layer 1 chemistry of OML-01. The solids content and loose crosslinking will determine the thickness of the thin, hydrogen bonded and covalently crosslinked adhesive contact lens. Upon rewetting and swelling, the thick adhesive in the meadows and the swollen, impinged adhesive in the short valley provide excellent fiber entrapment and fibril formation points. Additionally, the swollen adhesive on the lens cap is pressed into the fiber mat and contacts one or more fibers. Without being tied to theory, the strong surface chemical tendency of low glass transition temperature chains to pool in the meadows as the adhesive is dried down on the lens array for the first time produces a stretched membrane effect over the lens cap as the chain entangled, loosely crosslinked adhesive dries down after coating. By controlling the solids content and the crosslink density of a network that contains low glass transition temperature species, thin transparent conformal coating results. Alternatively, the overall shape of the conformal contact lens can be modified by changing the ratio of the side chains to include differing hydrophobes, either aliphatic or aromatic and differing hydrophils, such as ethoxylates or sulphonates.

In addition to a surface chemical driving force of low glass transition temperature species into the meadow, such as ethoxylate chains, the majority carboxylated polyvinyl alcohol is inherently well balanced for lens conformance.

Because of its unique properties, one very useful component for many embodiments of the present invention, worthy of further discussion is polyvinyl alcohol or PVOH. Polyvinyl alcohol has good hydrogen bonding properties with paper and has a range of refractive indices from 1.50-1.55, increasing with degree of hydrolysis. In its unmodified form, polyvinyl alcohol solutions (of 12% or lower concentrations) that have a high molecular weight and 99% hydrolysis, when wiped onto the polymeric microlenses and dried, have good thin layer lens conformation and nearly acceptable optics. Polymeric microlens-based security ribbons with simple PVOH as the only topside adhesive component have some adhesion in that some fibers remain bonded to the polymeric microlens array upon delamination, but the delamination force is not high and the results are not consistent. Moreover, the optical contribution of an unmodified PVOH film are not ideal.

Generally, PVOH has excellent hydrogen bonding potential and a high refractive index when highly hydrolyzed. There is a tradeoff between the molecular weight, the viscosity and the tensile strength when using PVOH. Low molecular weight PVOH has low tensile strength and cannot be used. Very high molecular weight PVOH, on the order of 230,000 daltons, has excellent tensile strength, but becomes viscous and is only practical in concentrations up to about 12% by weight in water. At these low concentrations, a single-pass coating of PVOH on microlenses results in a coating too thin to form much contact with fibers. Additionally, high molecular weight PVOH does not rewet quickly when inserted into the papermaking process. Unmodified PVOH would require a primer coating that is capable of wetting initially wet hydroxyls and covalently bonding with them in the course of drying to prevent detachment of the adhesive from the lens layer. This lens primer would require either epoxides or aldehydes, both under acid conditions with some heat from drying. Blocked isocyanates could act as a reactive primer for hydroxyl rich polymers such as PVOH, but the unblocking time is too slow for a coating line. If fast-acting, blocked isocyanates are later developed, they too could be used. Unmodified PVOH is not capable of bonding with wet strength resins under alkaline conditions other than through hydrogen bonding. Titanate crosslinkers can also be used to affix polyols to the microlens surface but they are expensive and the time-temperature requirements are not advantageous for a coating line. Alternatively, thermoplastic primers with a high density of hydrogen bonding and vander Waals bonding species could serve as a primer for unmodified PVOH.

More importantly, unmodified PVOH does not form fiber-adhering extensible fibrils when wet. Polyvinyl alcohol is available in many different modified forms from commercial suppliers. Carboxylated PVOH that is highly hydrolyzed has a high refractive index and is capable of reacting with either epoxides or azetidinium rings in the primer layer. Specifically, T-330H is a highly hydrolyzed (99%) grade of carboxylated PVOH from Nippon Gohsei of Japan. The same carboxylates will react at elevated temperatures with the wet strength resins of either PAE or PAAE type that coat paper fibers in banknote papers. The consistent and narrow molecular weight distribution of T-330H makes it an excellent candidate for a topside adhesive when used with microlenses embedded in paper. The presence of carboxylate and carboxylic acid groups make this material a rapid rewetting resin. The moderately high molecular weight also helps with swelling while preserving tensile strength.

The source of carboxylation in T-330H is a malaeic acid co-monomer. In its commercial form, some of the carboxylic acids are salted with sodium and some are not. A powerful technique for formulating adhesive formulations using this and other polyol-anhydride copolymers that are partially salted is to activate them into their original anhydride form with a stronger polyacid. One such commercially availably polyacid is a copolymer of acrylic acid and the sulphonic acid form of AMPS, pHreegard 4500, Calgon Corporation. Typically used as a water treatment additive to prevent scaling, such a polyacid when added in very small amounts to remove residual sodium from the carboxylated anhydride, -PVOH copolymer causes adhesion within the present invention to dramatically increase. By un-salting the anhydride, the anhydride is free to react with either expoxide rings in the paper wet strength resins or azetidinium rings, depending on which system is used by a given paper mill. Moreover, at elevated temperatures, upon drying the anhydride ring can react with hydroxyls within the paper network. When activated by desalting, T330-H and similar copolymers also self crosslink.

An alternative source of carboxylated PVOH can be derived from biological digestion of high hydrolysis PVOH of high molecular weight. For example, Celvol 165 from Sekisui USA, when bio-digested by several different species (well documented in the prior art), results in a mixture of carboxylic acid oxidation end products and aldehyde oxidation end products, as well as beta di-ketones. Fortunately, bacteria are capable of using low molecular weight PVOH as a carbon fuel source, leaving behind moderately high PVOH cleavage products with a mixture of carboxylic acid groups and aldehyde groups as a resulting modification of the PVOH with its high density of secondary hydroxyls. A 24-hour digestion at 28 degrees C. with mixed fungal and bacterial PVOH digesting species will prepare Celvol 165 for an excellent layer 2 component when admixed with modified polyvinyl amine and some form of polyvinyl amine crosslinker, most preferably one of high molecular weight and moderate reaction kinetics.

When polyvinyl alcohol of high hydrolysis extent (99%) and high molecular weight (ca 225 Kda) is biologically oxidized, a broad molecular weight distribution with carbonyl end groups results, which is free of low molecular weight molecules that are particularly detrimental to the tensile strength of the layer 2 adhesive. The refractive index of this modified PVOH is near 1.55. When the plano convex lens has a refractive index less than 1.55, the index depressing effect of polyvinyl amine brings the refractive indices of the lens and layer 2 into balance. When the refractive index of the polymeric plano-convex lens is greater than 1.55, it is customary in the art to add minor percentages of metal oxides in very small sub-micron particles to the adhesive to raise the refractive index thereby achieving a match. The metal oxide particles may or may not be surface modified. Polyvinyl alcohol that has been biologically oxidized to have aldehyde end groups will covalently react with the primary amines of polyvinyl amine thereby creating a rewettable, lyotropic bottle brush polymer that is well index matched, covalently reactive with the layer 1 adhesive and a good hydrogen bonder with layer 1 as well as the wet paper fibers.

Another commercially available PVOH modification is acetoacetyl-modified Z-410 and Z-200H from Nippon Gohsei. The Z-410 product has moderately high molecular weight and a high refractive index. The Z-200H product has a high degree of acetoacetyl substitution and a medium molecular weight on the order of 100,000 daltons. Both products can be modified with amines or aldehydes, which react with the acetoacetyl side chains. Both materials can be used effectively in the primer layer or the secondary adhesive as a bottlebrush polymer, elastomeric crosslinker. In particular, they react well with polyvinyl amine, have high refractive index, they are water soluble and rich in hydrogen bonders.

Polyvinyl amine has excellent wet adhesion to paper fibers and is sometimes used as a dry strength additive resin in some papermaking processes. Papers which use PAE or PAAE wet strength resins adhere very strongly to polyvinyl amine because of covalent Michael Addition bonds between the primary amine side chains of polyvinyl amine and the epoxy groups of activated PAE resin or the azetidinium side groups of PAAE resins. Additionally, the dense primary amine side groups of polyvinyl amine have strong electrostatic bonding with the carboxylic acid groups contributed by the carboxymethyl cellulose resins in PAE and PAAE wet strength systems. However, polyvinyl amine has a moderate refractive index—approximately 1.49—which does not come as close as polyvinyl alcohol to matching the optics of polymeric lenses.

Unmodified polyvinyl amine does have a strong adhesion to polymeric microlenses when they are formulated with at least some unreacted acrylates, which typically are UV-cured with a free-radical photoinitiator. As the acrylate or methacrylate monomers or oligomers crosslink, they will eventually become a glassy polymer with little mobility before all of the acrylate groups have been able to react. This is advantageous because no primer is required. To match the refractive index with microlenses with a refractive index above 1.50, an adequate amount of polyvinyl alcohol or other high molecular weight water soluble polymer such as polyacrylic acid should be blended with the modified polyvinyl amine. For the initially wet fibers to penetrate into the adhesive coating that conforms to the lens surface in the very short time between security thread insertion and when the paper is dried, designing the adhesive coating to be rapidly re-swellable is important. To achieve a good swelling and rewetting speed while maintaining a high refractive index, one method is to use high molecular weight PVOH with a high degree of hydrolysis that has been sequentially cleaved through partial oxidation, leaving carbonyl groups at the ends.

In general, polymer solutions in water or isopropyl alcohol were found, upon drying, to form conformal coatings if the surface chemistry of the coated on polymers was intermediate between being a strong wetting material and a phobic or repulsive material with respect to the layer being coated. Small increases or decreases in the surface wettability are achievable through grafted-on side chains, chosen from a rich library of commercially available monomers to increase or decrease the surface wetting of the polymer. These modifications are a sensitive strategy for tuning the surface conformation properties of adhesive solutions to spontaneously conform to a polymeric microlens array as the solution is coated on and the solvent (most preferably water) is subsequently evaporated. The behavior of the side chain monomers alone on the polymeric array is the best predictor of the increased or decreased wettability that such a side chain grafting would contribute. The shape of the surface conformation is co-related with the following:
1. The method used to coat the solution on
2. The dynamics and method of drying the solution,
3. The solids content of the solution
4. The surface chemistry of the solids
5. Any crosslinking that occurs as the solution dries down to a conformal coating.
6. Any chemical reactions with the coated surface

All of these factors can be varied until the desired thickness and shape of the self assembled contact lens array has been tuned. Excellent adhesive formulations can be made off-line using drawdowns and then those formulations can be tuned to the coating and drying dynamics of the in-line film production machine. This fact demonstrates that the surface chemistry and solids content are the two most dominant co-factors in determining the shape of the conformal coating.

Because primary amines, sulphonates, and carboxylates are so strongly adhesive with wet paper, especially wet paper that is coated with wet strength resins such as activated PAE or PAAE, the second adhesive coating is a high refractive index, water soluble composition that is both lens conforming and rich in nucleophiles, such as carboxylates, sulphonates and primary amines. When applied on top of the first layer, those primary amines from the second layer that contact the amine-reactive side chains from the first dried-on layer will covalently react quickly. In addition to fast reacting primary amines in the second layer adhesive, there are slower reacting carboxylates that covalently bond with wet strength resins. Before the carboxylates of the second layer adhesive bond covalently, they are an adhesion promoter with wet paper fibers.

Both the first layer and second layer are designed to be rich in hydrogen bonding species. Consequently, those groups that do not supply covalent bonding contribute to the adhesion between layer 1 adhesive and layer 2 adhesive through hydrogen bonding. The strong concentration of hydrogen bonding species in the second layer is also compatible with attachment to the fibers during the papermaking process. By including a dense number of hydrogen-bonding species within the first layer, and even more hydrogen bonders as a percentage of total moieties within the second layer, the transition from hydrophobic polymer to paper-loving, hydrophilic polymer is made without the loss of attachment. Refractive index matching and conformal lens shaping keeps the optics in tune provided the newly thickened lenses do not touch excessively.

Returning to layer 1, it is a classic primer layer or tie-coat that has the unique properties of being lens-conforming, transparent, refractive-index-compatible with the lens beneath, rich in hydrogen bonders, sufficiently rich in primary-lens solvating species to improve lens adhesion, self-crosslinking and co-reacting to build molecular weight to a macromer and, most preferably, possessing some chemically-reactive moieties which covalently bond with the primary-lens chemistry. Above all layer 1 must present upon its surface a rich number of un-reacted side-chains ready to co-react with well anchored moieties in layer 2.

### Coating

The topside adhesive of the present invention is designed to be coated inline with the fabrication of micro-optical security threads. At some point in the security thread creation process, downstream from the point that the plano-convex lenses are bonded to the carrier film, the first adhesive layer is coated onto the plano-convex lenses as a dilute, metered on solution that is dried. For the lens compositions which are based on acrylate chemistry that is UV-cured with a free-radical photoinitiator, the first layer adhesive also contains side chains of acrylates which react into the crosslinking lens surface. Most preferably, any acrylate-based first layer adhesive would be deposited dilutely in an isopropyl alcohol solvent if a primer layer is used at all. It is advisable that the evaporated alcohol be vented through a catalytic oxidizer to eliminate the release of volatile organic components, VOCs. For lens compositions that are based on a thermal reflow of micro-replicated thermoplastics, the side chains of the first adhesive layers are selected as strong solvents of the thermoplastic lens material.

Layer 1 can be coated with a Meyer rod coater provided the supply of OML-01 is not recirculated in a pan.

Layer 2 can be coated on by a variety of methods but must be metered on at a precise coated weight across the web to avoid yield losses from impinged lenses due to local excess coating.

In one embodiment, layer 2 is designed never to let go of layer 1 because of the covalent linkages between residual nucleophiles in layer 2 and a surplus of electrophile species, or in some cases acetoacetyl and azetidinium rings in layer 1. The high concentrations of hydrogen bonding groups in layer 1 and layer 2 contribute to their high adhesion and cohesion in the dry state. The covalent linkages between layer 1 and layer 2 provide the needed strength in the wet state during the initial stages of the papermaking process. Layer 2 is also designed to swell upon rewetting in the papermaking process. Unmodified, high molecular weight polyvinyl alcohol does not rewet rapidly, yet it is strong. Formulations with a compatible refractive index that have residual nucleophiles and are rheologically lyotropic, swellable and tacky upon rewetting, are uniquely well suited to the previously stated constraints of the present invention.

Lyotropic, rewettable formulations have a tendency to form a rope-like connection with a large radius of curvature when poured or contacted with a micro-rough surface in the wetted state. One source of lyotropic components is bottlebrush polymers, in this specific case, bottlebrush polymers of polyvinyl amine (or PAAE resins or acetoacetyl modified PVOH and other water soluble, high tensile strength polymers). The side chains may be composed of a short ethylene oxide(2) acrylate, such as Sartomer SR256, Michael-Addition reacted onto the polyvinyl amine or medium chain methoxy ethylene oxide(11) acylate in the form of Sartomer SR553. The purpose of these low glass transition side chains is to depress the glass transition temperature of the wet strength resins which coat the paper fibers (PAE or PAAE resins). In addition to the low glass transition temperature side chains, in those embodiments in which biodegested polyvinyl alcohol is used, the majority of the polyvinyl amine side chains are populated by oxidized polyvinyl alcohol, whose end groups consist of carbonyls in the form of aldehydes or carboxylic acid, or beta-diketones. The aldehydes react readily with primary amines and the carboxylic acids can be made to do so with an EDC crosslinker, as is known in the art for peptide linkages, but the EDC catalyst would introduce a small molecule and is not preferred. Carboxylic acid end groups or side chains of water-soluble polyvinyl alcohol also form an associated salt with primary amines provided they are not previously salted with sodium. The 1,2 beta-diketones of biodigested polyvinyl alcohol are very similar to the 1,3 beta-diketone which is acetoacetyl of the Z class polyvinyl alcohol from Nippon Gohsei. Furthermore, the carboxylated polyvinyl alcohol from Nippon Gohsei is a copolymer with maleic acid with some of the carboxylic acids salted and others in the acid form. One can either biodigest commodity grade polyvinyl alcohol or purchase very similar products with a more consistent composition from Nippon Gohsei.

Additionally, a small amount of polyfunctional amine-reactive crosslinker may be mixed into layer 2 as it is being pumped toward the metering and drying stages within the coating line which produces the micro-optical film. This crosslinker is hindered in its reaction by the polyamine-bottlebrush side chains within the layer 2 formulation so that amine reactions, crosslinking, and the attendant viscosity increase do not, for the most part, occur until after the film is dried down and the polymer chains are left to diffuse. Diacrylates with strong Vander Waals force bonding between the reactive ends can be useful for this purpose as are dimethacrylates and partially amine substituted (reacted) acetoacetyl side chain modified polyvinyl alcohol in small percentages by total weight of the second coat. Adding low glass transition temperature ethoxylated (EO) side chains on the polyvinyl amine bottlebrush polymer also contribute to polymer diffusion and amine/crosslinker reaction after the coating is on the shelf in the slit ribbon form. A small amount of crosslinker will result in a slightly elastomeric rheology in the wetted form while still allowing for significant rope-like extensibility toward the paper surface. A high amount of crosslinker will increase the durometer and tensile strength of the wet elastomer, but will also reduce extensibility and conformability in the wet state and is undesirable. One such crosslinker is acetoacyetyl modified polyvinyl alcohol, Z410 or Z200H or other Z series PVOH modifications from Nippon Goshei of Japan.

Both lyotropic rheology and high tensile strength are desirable properties of the layer 2 adhesive. In general, a long tube or cage-like molecule with a small cross sectional diameter that does not scatter light with significant network covalent crosslinking within the surface of the tube and some reactive function groups that can bond with the rest of the adhesive formulation is a good paradigm for raising the tensile strength of the bonded layer 2 adhesive to a level such that cohesive failure does not occur. These long, cage-like macro-molecules in minor amounts are good contributors to lyotropic behavior and high tensile strength.

One example of a non-light scattering long cage-like macromolecule for use in the present invention is bacterial cellulose. In particular, bacterial cellulose that has been epoxidized, either biologically or with epichlorohydrine, can act as a crosslinker, a lyotropic contributor, and an increaser of ultimate tensile strength of the bottle-brush/nano-cellulose-PVOH system. Other electrophilic side group substitutions are also useful. Alternatively, the bacterial cellulose can be substituted with nucleophiles which will crosslink with electrophile substituted polymers in the layer 2 adhesive system such as acetoacetile substituted PVOH or hindered PAAE resin. The small dimensions of bacterial cellulose allow for blending into the formulation with an approximate weight averaged refractive index contribution of 1.54. In minor amounts of 1 percent or less it is transparent and a strong tensile strength contributor. Natta de Coco is a commercially available source that can be redisperse through many techniques known in the art or the material can be fermented with acetic acid and sucrose using known biological procedures.

Yet another contributor to lyotropic behavior and a good tensile strength contributor as a minor crosslinker is functionalized imogolite reacted with the polyvinylamine bottle brush. When immogolite, a hollow tube ceramic clay that is transparent when well dispersed, is functionalized with an organo-silane such as triethoxysilane to impart an epoxidized, covalently bonded surface, it becomes available to react with the highly hindered bottlebrush polyvinyl amine. In small concentrations near 1 percent, the immogolite is a good contributor to wet state elastomeric properties of the adhesive in the papermaking process as well as lyotropic rheology in the unreacted condition. The intent is to have large radius adhesive fibrils that are free enough to extend in the wet state, yet do not break in the wet or dry state. Functionalized immogolite is capable of contributing to both high tensile strength and a good balance of crossslinking. In low concentrations, its nano-scale cross section makes it transparent in liquid or solid solutions. Hoshino et. al published in Polymer Bulletin, Vol 29 (1992) pp. 453-460 an article entitled “Lyotropic Mesophase Formation in PVA/Imogolite Mixture”, incorporated herein in its entirety by reference. This work differs from the present invention in that the present invention does not require imogolite and when used it is best used as a silane functionalized particle blended and eventually co-reacted with complementary side chains within the high moleculare weight polymer mixtures of the present invention. Therefore as practiced in the present invention, imogolite may optionally be coreacted with any of several functionalized, soluble, high molecular weight polymers.

If in the course of adding low glass transition temperature side chains to either or both the polyvinyl amine component of the level 2 adhesive or the much smaller constituent of the acetoacetyl modified polyvinyl alcohol long range crosslinker, one can find that the refractive index has fallen and the optics of the microlens-based feature suffers. To compensate, a small fraction of nano-scale metal oxides such as ziroconia, alumina, or titania may be added to the level 2 formulation as is common in the prior art for adjusting upward the refractive index of polymeric formulations. Silane modification through organic molecules coupled to triethoxy silane or trimethoxy silane can custom tailor the surface of such inorganic nanoparticles and prevent them from agglomerating into a high index light scattering particles. Inorganic particles on the order of 30 nm or less tend to approximately volume average their refractive index contributions with the surrounding matrix. Titania in the rutile form has such a high refractive index, 2.9, or even 2.49 for the anatase form, that small amounts can help compensate for bulking up on low Tg side-chains with lower refractive indices.

Another way to raise the refractive index of the present invention is to blend in branched polyesters or dendrimers that are surface modified with primary amines, hydroxyls or carboxylates. Some polyesters have a refractive index of 1.57 without the use of halogens. High molecular weight branched polymers with hydrophilic surfaces can also be useful for creating textured coatings as they dry down with linear and bottle brush polymers.

Not all wetstrength resins use polyelectrophiles. Polynucleophiles can also be used for wet strength. For example, polyvinylamine is sometimes used as a wet strength resin. When that is the case, the strategy for the present invention is the same, but the polarity of the layers is inverted. The primer then uses polyvinyl amine with adhesion promoting grafted on side chains in the majority and hindered polyelectrophiles like Polycup 7360 with grafted on adhesion promoting side chains in the minority. Layer 2 uses acetoacetyl modified polyvinyl alcohol in the majority with some highly hindered bottle brush polymers of polyvinyl amine with ethoxylated substitutions as a slow crosslinker. Carboxylated polyvinyl alcohol can be used as well to dilute the two reacting species as they are pumped and mixed together, but it is used in smaller amounts because it will not graft well with the primer or the fibers, unless it is activated by desalting a maleic acid monomer using a stonger polyacid such as acid AMPS-acrylic acid copolymer, However, the majority Z-410 will. Again it is preferred to balance the hydrophilic to hydrophobic ratio of the layer 2 adhesive to match that of the wet fibers coated in wet strength resin. Small hydrocarbon clusters are sparsely grafted onto the constituents of the layer 2 formulation to maximize wetting and Vander Waals bonding.

Generally, the design of the primer layer seeks to mimic the surface chemistry of the fibers so the layer 2 adhesive can be optimized for a single set of surface characteristics, therby binding well with the primed lens surfaces and fibers alike. The layer 2 adhesive uses moisture from the papermaking process to swell and soften the layer 2 adhesive so that it is extensile with large radii pads or fibrils connecting the lens array and fibers. Ethoxylated substitutions and other low glass transition temperature substitutions help to drive a significant fraction of the lightly crosslinked coating into the valleys and meadows between the lenses leaving each lens surrounded by a relatively thick layer of adhesive. The strong surface chemical driving force that yields a largely level pool of adhesive network in the trenches helps to stretch the remaining adhesive like a taught membrane over the microlenses. The resulting conformal coating, when well index matched preserves the optics of the system with a slight improvement in image contrast as the fattened lenses now have smaller inter-lens areas.

### DETAILED DESCRIPTION OF DRAWINGS

FIG. 1A depicts section view of uncoated microlenses [10] spaced apart in closest approach by a distance [70] on a transparent, flexible carrier film [20] with image array layer [30] along a closest approach transect [100].

FIG. 1B. depicts a hexagonal close packed array of microlenses [10] spaced apart at closest approach by a distance [70] along a closest approach transect [100] and a farthest line of sight transect [200]. The concave area between the lenses [50] is called in the application, the “meadow.”

FIG. 2B shows the dried on coating in the conformal area on the surface of the microlens and at the impingement point at closest approach in the short valley [400a]. The area of the meadow [50] is reduced by the fattening up of the lens array and consequently the non-productive light from this region is reduced. Consequently the contrast is slightly improved.

FIG. 3A shows the space between lenses along the long valley [60]

FIG. 4B shows the dried on adhesive forming a conformal coating that is thin on the lenses [400] and thick in the meadows [400b] and valleys [400a] but not to the point of harming the optics. The ability of the thick reservoir of adhesive in the meadows to form extended rewetted adhesive fibrils surrounding every lens, together with pad and fibrils of adhesive on the lenses is one of the keys to a high-force delamination failure mode.

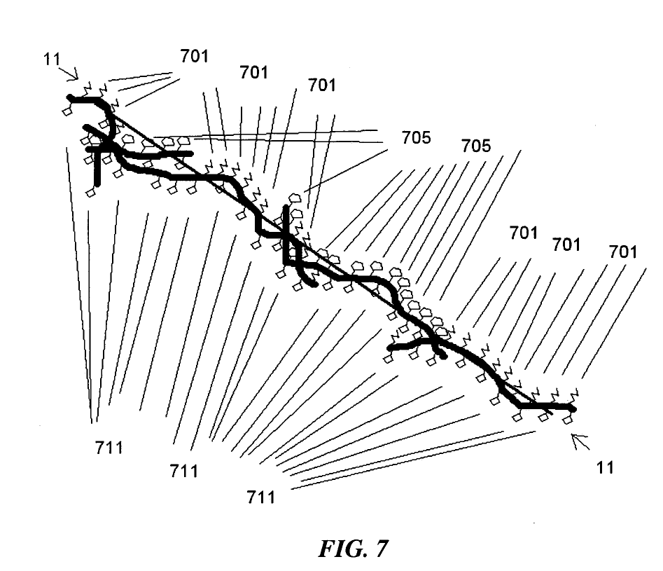

FIG. 7 Depicts THF pendant groups [711] that have been reacted onto various high molecular weight reactive linear polymers in the primer layer 1. These groups dissolve into the polymer surface thereby promoting adhesion. Acetoacetyl groups [701] and azetidinium rings [705] remain available for reaction with primary amines in both cases and with carboxylates in the case of azetidinium rings.

FIG. 8 Shows the primer layer [300] with adhesion promoters and residual reactive sites coated by the topside adhesive layer [400] resulting in partially embedded fiber [460], a slightly extended fibril with large contact radius [450] and extended adhesive fibril [440].

FIG. 9 Is an abstract stack of adhesion interfaces showing the cohesion and adhesion zones from the carrier film to the lenses, adhesives, and fibers. Interface [0] is the cohesion zone within the carrier film. Interface [1] is the boundary between the carrier and the primary lens. Interface [2] is the cohesion zone within the lens. Interface [3] is the boundary between the lens and the primer. Interface [4] is the cohesion zone within the primer. Interface [5] is the boundary between the primer and the rewettable topside adhesive. Interface [6] is the cohesion zone within the rewettable topside adhesive. Interface 7 is the boundary between the adhesive and the fiber. Interface [8e] is the enhanced fiber-to-fiber bond in near proximity to the rewettable adhesive layer and interface [8] is the un-enhanced fiber-to-fiber bond in far proximity from the rewettable adhesive layer. Interface [9] is the cohesion interface within the fiber which can best be expressed as the fiber tensile strength.

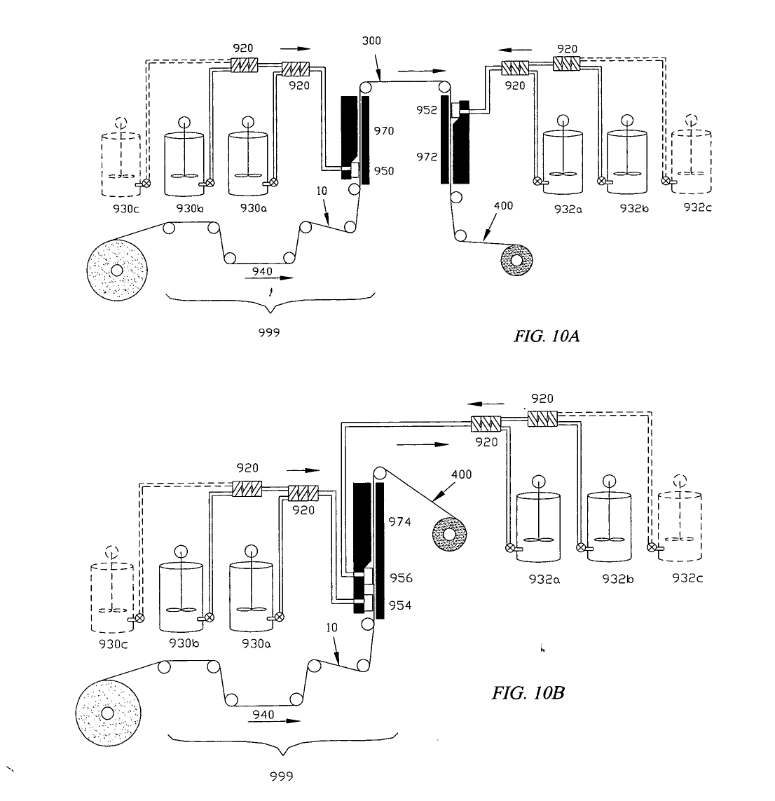

FIG. 10A shows a process for making micro-optical materials on a transparent carrier film [999]. At some point after the lenses have been formed [940], the primer layer is coated on by continuous inline pumping and mixing [920] from one part [930a], two part [930a][930b] or three part [930a][930b][930c] solution at a process proportional rate toward a coater [950] and subsequent dryer [970]. Subsequently a similar process proportion pumping and mixing [920] subsystem brings together the multi components of the topside adhesive solution OML-02 to the coating station [952] and dryer [972]. Most preferably each coating would consist of no more than two components.

FIG. 10B shows the same arrangement but with two sequential slot-die coaters and a single drying section. Technically, a very large number of coating layers could be put down wet and dried at once through sequential slot-die coating.

Some formulations would require the sequential drying arrangements of FIG. 10A and other formulations would enjoy the simplicity of the process shown in FIG. 10B.

### SPECIFIC PREFERRED EMBODIMENTS

One skilled in the art will appreciate that changing coater line speed and changing dryer temperature and air flow may require minor optimizations of the monomer side-chain used in the specific preferred embodiments herein disclosed. It is a robust characteristic of the present invention that such fine tuning of the optics is possible. In fact, two such optimizations can be pre-formulated, one which makes the adhesive contact lens form a short focal length and another which spontaneously dries down to a long focal length. The operators of the coating line may then proportion the two formulations together until the microlens array is tuned to the correct focal length. In this way the various embodiments of the present invention can be tuned for both adhesion and optics while reacting robustly to changing conditions in the manufacturing setting.

The results are judged in terms of optics and adhesion. For adhesion, it is desirable that the maximum failure mode be achieved. A less than optimal tuning of the system can result in a lesser failure mode that may prove to be adequate. Because many formulations have achieve the maximum force failure mode, there is no reason to accept a lesser performance because it may result in unexpected failure during document circulation as the paper and adhesive age. Optics are judge in terms of clarity and focus. Previously the present disclosure described how two different formulation of focal length can be blended in-line to tune the optics of the film according to either seasonal differences in manufacturing conditions, like starting temperature, or evolutionary changes like increasing line speeds. Therefore, an adhesive formulation that has excellent adhesion and has a focal point near the image plane, whether short, long or “spot-on” is useful.

### Formulation 840

OML-01 is a one part 3% solution of polyurethane emulsion polymer from Michelman called U2-01 diluted down with distilled water from the 59% solution as shipped. This can be used as a 0.5% solution to a 6% solution with near 3% solution giving best results.

Coat with Meyer Rod 0-2 for best result.

### OML-02A

Nippon Gohsei's T300H is hydrated as 32 grams in 400 ml of distilled water and stirred with heat without scortching on the bottom until hydrated and clear. To this batch add 17 drops of acrylic acid, acid-AMPS copolymer known as pHeegard 4500, Calgon Corporation. Stir over-night at low RPM. Add the following blend of specialized polyvinyl alcohol:

### 400.00 g of T-330H Nippon Gohsei

66.66 g of Celvol 165 PVOH @ 6.5% concentration in distilled water

13.33 g of Celvol 125 PVOH @ 6.5% concentration in distilled water

3.33 g of Nippon Gohsei WR-21 @ 10% concentration in distilled water

7.33 g of Nippon Gohsei Z-410 @ 6.5% concentration in distilled water

### OML-02B-1

5.0 g of Na+AMPS at 50% concentration from Lubrizol

3.0 g SR 256 EOEO acrylate from Sartomer
0.25 g CD553 medium chain ethoxylated mono-acrylate from Sartomer
2.0 g CN 147 from Sartomer
6.0 g teriary butyl acrylate from BASF
1 drop SR212B from sartmer taken together the group was vigorously stirred
0.5 grams from the above was added to the following blend
20.0 g Lupamin 9095 polyvinylamine BASF
20.0 g taken from a 90 g sample with a single drop of a 10% solution of Nippon Gohsei WR-21.

The water with WR-21 drop was blended with the lupamin first then the 0.5 g of the above dispersion was added

### OML-2B-2

Celvol 165 at 6.5% solids

Take three parts OML-2B-1 to every one part OML-2B-2 and blend well under low shear mixing to make OML-2B

Through a helical mixer blend 4 parts OML-2A to one part OML-2B and coat with Meyer rods 2, 3, and 4 with 3 giving best results.

Formulation 840 when inserted into currency paper with a PAE wet-strength resin resulted in maximum possible fiber bridge adhesion with a long focal length, still within useful range.

### Formulation 851

OML-01 is a one part 3% solution of polyurethane emulsion polymer from Michelman called U2-01 diluted down with distilled water from the 59% solution as shipped. This can be used as a 0.5% solution to a 6% solution with near 3% solution giving best results.

Coat with Meyer Rod 0-2 for best result.

### OML-02A

Nippon Gohsei's T300H is hydrated as 32 grams in 400 ml of distilled water and stirred with heat without scortching on the bottom until hydrated and clear. To this batch add 13 drops of acrylic acid, acid-AMPS copolymer known as pHeegard 4500, Calgon Corporation. Stir over-night at low RPM. Add the following blend of specialized polyvinyl alcohol:

### 400.00 g of T-330H Nippon Gohsei

66.66 g of Celvol 165 PVOH @ 6.5% concentration in distilled water

13.33 g of Celvol 125 PVOH @ 6.5% concentration in distilled water

3.33 g of Nippon Gohsei WR-21 @ 10% concentration in distilled water

7.33 g of Nippon Gohsei Z-410 @ 6.5% concentration in distilled water

### OML-02B-1

60.0 g Lupamin 9095 polyvinylamine BASF
60.0 g taken from a 90 g sample with a single drop of a 10% solution of Nippon Gohsei WR-21.
Add 6 drops CD553 to the 120 g blend

### OML-2B-2

Celvol 165 at 6.5% solids

Take three parts OML-2B-1 to every one part OML-2B-2 and blend well under low shear mixing to make OML-2B

Through a helical mixer blend 4 parts OML-2A to one part OML-2B and coat with Meyer rods 2, 3, and 4 with 3 giving best results.

Formulation 851 when inserted into currency paper with a PAE wet-strength resin resulted in maximum possible fiber bridge adhesion with a long focal length, still within useful range and shorter than that for formulation 840. Note that the primary formulation differences were the side-chains added to polyvinylamine that had been made into clusters with a lightly functionalized dilute solution of WR-21.

One skilled in the art will appreciate that a broad catalog of mono-acrylates including THF acrylate and propoxylated THF acrylate can be used to maintain excellent adhesion while changing slightly the hydrophobicity of the side-chains reacted onto polyvinylamine.

### Alternate Embodiment

When biologically oxidized and digested PVOH is used from Celvol 165 as a starting point, the material is first mixed at 10% concentration by weight and inoculated with a mixed culture of known bacterial and fungal species that consume short chains of PVOH, leaving behind large chains of various lengths and functionalizations including carboxylic acid, aldehydes, and beta di-ketone. Incubated at 28 degrees C. for 24 hours with very slow intermittent stirring, the culture is concentrated by dehydration to 17% by weight. To 45 g of this solution are added 12 g of polyvinylamine in the form of Lupamin 9095. Stirred, the digested PVOH begins to react both electrostatically and covalently with the PVam leading to PVam clusters. To this is added 0.01 parts isopropanol (IPA) drops of SR212B diacrylate from sartomer in 1 gram of IPA. The diacrylate solution is added slowly as 22 drops with rapid stirring. This blended formulation serves as a functional topside adhesive when coated on a well anchored primer rich in acetoacetyl groups and azetidinium groups. The coating is drawn down on the top of the lenses with a 1 inch chrome plated coating rod and dried at 147 degrees C. Drying the film in excess of 150 degrees C. results in a weakening of the interface between the lenses and the carrier.

The alternate embodiment does not make use of bottle brush polymers. Provided the formulation is first passed through a 100 micron sieve, the dried down coating is even and free of haze associated with excessive coat weight. An amine tolerant biocide is required and can be purchased commercially.

While various embodiments of the present invention have been described above, it should be understood that they have been presented by way of example only, and not limitation. Thus the breadth and scope of the present invention should not be limited by any of the exemplary embodiments.

Having thus described the invention, what is claimed is:

1. A system of adhesive solutions which, when coated onto a micro-optical film, form one or more layers of adhesive contact lens arrays self-assembled onto micro-optical elements in conformal registration with existing micro-optical elements, while providing a strong attachment bond between the coated-on side of the micro-optical film and wet paper fibers as the micro-optical film is inserted into the paper pulp as the paper is being made, such that through the dewatering, compression, drying, lateral contracting and longitudinal elongation of the paper web, the micro-optical film is tenaciously bonded to the network of dried paper fibers in areas where the coated-on side is embedded in the paper and the optical properties of the micro-optic film are at least maintained in the areas where the micro-optical film is exposed.

2. The adhesive solutions of claim 1, wherein high molecular weight water soluble polymers with short reactive side groups are selected to closely match the refractive index of the underlying micro-optical array.

3. The adhesive solutions of claim 2, wherein the solids content is adjusted to leave behind a coating of the desired thickness once the solution is coated on and the solvent is evaporated.

4. The high molecular weight water soluble polymer of claim 2, wherein the surface chemistry and dried-down coating shape are adjusted through click-chemistry of short to medium length side groups onto the co-reactive short side chains of the high molecular weight polymer of claim 2.

5. The click chemistry reaction of claim 4, wherein the short side chains of the high molecular weight polymer are Michael Addition reacted by one or more species of complimentary short to medium weight monomers selected to modify the wettability of the high molecular weight polymer to the surfaces it contacts.

6. The click chemistry reaction of claim 4, wherein the short side chains of the high molecular weight polymer are Michael Addition reacted by complimentary short to medium weight monomers selected to depress the glass transition temperature of the high molecular weight polymer and the surfaces it contacts.

7. The click chemistry reaction of claim 4, wherein the short side chains of the high molecular weight polymer are Michael Addition reacted by complimentary short to medium weight monomers selected to solvate the surfaces contacted by the high molecular weight polymer.

8. The click chemistry reaction of claim 4, wherein the short side chains of the high molecular weight polymer are Michael Addition reacted by complimentary short to medium weight monomers selected to modify the wettability of the high molecular weight polymer to the underlying micro-optical film.

9. The adhesive solution of claim 1, wherein a set of two or more high molecular weight water soluble polymers are pumped and blended together for coating onto the micro-optical film as it is being made at a proportional rate such that the thin conformal coating will be the desired thickness.

10. The set of high molecular weight soluble polymers of claim 9, wherein a single coating is dried to form a functional adhesive with matched and conformal optical properties.

11. The set of high molecular weight polymers of claim 9, wherein two successive coatings are metered on and dried to form a functional adhesive with matched and conformal optical properties.

12. The set of high molecular weight soluble polymers of claim 9, wherein three successive coatings are metered on and dried to form a functional adhesive with matched and conformal optical properties.

13. The set of high molecular weight polymers of claim 9, wherein one more members of the set have side chains that form hydrogen bonds.

14. The set of high molecular weight polymers of claim 9, wherein one of more members of the set covalently react with each other through complimentary reactive side groups.

15. The set of high molecular weight polymers of claim 9, wherein prior to their incorporation into the coating process, a linear polymer of claim 9 is rendered into a branched cluster by pre-mixing with a minor amount of a polyfunctional click-chemistry compliment.
